(19) United States
(12) Patent Application Publication
(10) Pub. No.: US 2019/0128693 A1
(43) Pub. Date: May 2, 2019

(54) SYSTEMS AND METHODS FOR STATIONS LOADING AND DISPLAY

(71) Applicant: BEIJING DIDI INFINITY TECHNOLOGY AND DEVELOPMENT CO., LTD., Beijing (CN)

(72) Inventor: Wanqiu SONG, Beijing (CN)

(73) Assignee: BEIJING DIDI INFINITY TECHNOLOGY AND DEVELOPMENT CO., LTD., Beijing (CN)

(21) Appl. No.: 16/220,149

(22) Filed: Dec. 14, 2018

Related U.S. Application Data
(63) Continuation of application No. PCT/CN2018/108688, filed on Sep. 29, 2018.

(30) Foreign Application Priority Data
Sep. 30, 2017 (CN) 201710920215.9
Sep. 30, 2017 (CN) 201710944891.X

(51) Int. Cl. G01C 21/36

(52) U.S. Cl. CPC G01C 21/367; G01C 21/3682; G01C 21/3664

(57) ABSTRACT

The disclosure relates to a system and method for stations display. The method may include obtaining a scale associated with a display area of a map. The scale associated with the display area of the map may be a relationship between a distance at ground and a corresponding distance on the map. The method may also include determining whether to display one or more stations on the display area of the map based on the scale associated with the display area of the map.

### CROSS-REFERENCE TO RELATED APPLICATIONS

This application is a continuation of International Application No. PCT/CN2018/108688, filed on Sep. 29, 2018, which claims priority to Chinese Patent Application No. 201710920215.9, filed on Sep. 30, 2017, and Chinese Patent Application No. 201710944891.X, filed on Sep. 30, 2017, the entire contents of which are hereby incorporated by references.

### TECHNICAL FIELD

The present disclosure generally relates to map technical field, and in particular, to systems and methods for stations loading and display.

### BACKGROUND

With the development of online to offline service techniques, stations and specific travel route (e.g., a bus line and/or subway line) are loaded to be displayed on a digital map provided by a map application implemented in the electronic devices. The bus and/or subway in motion may be displayed on the specific trajectory in the map. Information and data associated with all stations in the public transportation of a city may be large. When a user travels in an area of the city, useful information are more obtained from nearby stations than the farther stations Therefore, it is not necessary to load all the stations in the city in the digital map after the user launches the map application. When the user drags the map on the screen of the electronic device, the display area on the user interface may change and the stations in the newly displayed area cannot be loaded and displayed efficiently, which reduces the user satisfaction of the map application.

Moreover, there may be two or more stations associated with a specific location, e.g., an upstream station and a downstream station which may be located on different sides of the road but not too far apart. When these stations are displayed on the map application, different stations may be overlapped because the display area is limited and the display scale is relatively high. In particular, the upstream and downstream stations are more likely to overlap because they are closer together, causing elements (e.g., icons representing stations) on the map unclear and confused. Therefore, there is a need to provide system and method to improve the user's experience of the map application.

### SUMMARY

In a first aspect of the present disclosure, a system for stations display is provided. The system may include at least one storage device and at least one processor. The at least one storage device may include a set of instructions. The at least one processor may be configured to communicate with the at least one storage device. When executing the set of instructions, the system may be configured to perform one or more of the following operations. The system may obtain a scale associated with a display area of a map. The system may also determine whether to display one or more stations on the display area of the map based on the scale associated with the display area of the map.

In some embodiments, the system may be configured to perform one or more of the following operations. The system may display at least one of the upstream station or the downstream station on the display area of the map, or the system may display neither the upstream station nor the downstream station on the display area of the map.

In some embodiments, the system may be further configured to perform one or more of the following operations. The system may display the upstream station and the downstream station on the display area of the map in response to a determination that the scale associated with the display area of the map is less than or equal to a first threshold. The system may display the upstream station or the downstream station on the display area of the map in response to a determination that the scale associated with the display area of the map exceeds the first threshold and is less than or equal to a second threshold. The system may display neither the upstream station nor the downstream station on the display area of the map in response to a determination that the scale associated with the display area of the map exceeds the second threshold.

In some embodiments, the system may be further configured to perform one or more of the following operations. The system may display the upstream station and the downstream station on the display area of the map in response to a determination that the scale associated with the display area of the map is less than a first threshold. The system may display the upstream station or the downstream station on the display area of the map in response to a determination that the scale associated with the display area of the map exceeds or equals the first threshold and is less than a second threshold. The system may display neither the upstream station nor the downstream station on the display area of the map in response to a determination that the scale associated with the display area of the map exceeds or equals the second threshold.

In some embodiments, the first threshold may be equal to 10, and the second threshold may be equal to 100.

In some embodiments, the system may be further configured to perform one or more of the following operations. The system may receive a signal from a client terminal, the signal indicating an operation instruction for zooming the display area of the map. The system may determine the scale associated with the display area of the map based on the signal.

In a second aspect of the present disclosure, a system for stations display is provided. The system may include at least one storage device and at least one processor. The at least one storage device may include a set of instructions. The at least one processor may be configured to communicate with the at least one storage device. When executing the set of instructions, the system may be configured to perform one or more of the following operations. The system may obtain a current position of a user, the current position being a first center position of a map. The system may load a plurality of first stations within a first pre-determined distance from the first center position. The system may display a first sets of stations including at least one portion of the plurality of first stations within a display area of the map on the map. The system may receive a signal from a client terminal, the signal including an operation instruction for changing the display area of the map. The system may obtain a second center position of the map based on the changed display area of the map. The system may determine a distance between the first center position and the second center position. The system may determine whether the distance between the first center position and the second center position exceeds a second pre-determined distance. The system may load a plurality of second stations within the first pre-determined distance from the second center position in response to a determination that the distance between the first center position and the second center position exceeds the second pre-determined distance. Each of the plurality of second stations may be different from one of the plurality of first stations. The system may display a second set of stations including at least one portion of the plurality of second stations within the changed display area of the map on the map.

In some embodiments, the system may be further configured to perform one or more of the following operations. The system may display the first set of stations on the map in response to a determination that the distance is less than or equal to the second pre-determined distance.

In some embodiments, the system may be further configured to perform one or more of the following operations. The system may determine a current city the user locates at. The system may obtain the current location of the user based on the current city the user locates at.

In some embodiments, the first pre-determined distance may be equal to a sum of the second pre-determined distance and a distance between a boundary of the display area of the map and the first center position or the second center position.

In a third aspect of the present disclosure, a system for displaying points of interest (POIs) is provided. The system may include at least one storage device and at least one processor. The at least one storage device may include a set of instructions. The at least one processor may be configured to communicate with the at least one storage device. When executing the set of instructions, the system may be configured to perform one or more of the following operations. The system may obtain a scale associated with a display area of a map from a client terminal. The scale associated with the display area of the map may be a relationship between a distance at ground and a corresponding distance on the map. The system may compare the scale associated with the display area of the map with at least one of a first threshold or a second threshold. The system may determine whether to cause the on-demand service platform to display one or more target POIs on the map display area based on the comparison.

In some embodiments, the one or more targets POIs may include at least one of an upstream station or a downstream station.

In some embodiments, the system may be further configured to perform one or more of the following operations. The system may cause the on-demand service platform to display the upstream station and the downstream station on the map in response to a determination that the scale associated with the display area of the map is less than or equal to the first threshold.

In some embodiments, the system may be further configured to perform one or more of the following operations. The system may cause the on-demand service platform to display one of the upstream station and the downstream station on the map in response to a determination that the scale associated with the display area of the map is greater than or equal to the first threshold and is less than or equal to the second threshold.

In some embodiments, the system may be further configured to perform one or more of the following operations. The system may cause the on-demand service platform to display neither the upstream station nor the downstream station on the map in response to a determination that the scale associated with the display area of the map is greater than or equal to the second threshold.

In some embodiments, the first threshold may be less than or equal to 10, and the second threshold may be greater than or equal to 100.

In some embodiments, the system may be further configured to perform one or more of the following operations. The system may receive a signal from the client terminal provided by the on-demand service platform. The signal may indicate an operation instruction for zooming the display area of the map. The system may determine the scale associated with the display area of the map based on the signal.

In some embodiments, the system may be further configured to perform one or more of the following operations. The system may obtain a current position of a user associated with the client terminal on a display area of the map. The current position of the user being provided by the on-demand service platform. The system may designate the current position of the user as a first center position of the map. The system may load one or more first POIs within a first pre-determined distance from the first center position. The system may obtain a signal from the client terminal, the signal indicating an operation instruction for changing the display area of the map. The system may obtain a second center position of the map based on the changed display area of the map. The system may determine a distance between the first center position and the second center position. The system may compare the distance between the first center position and the second center position with a second pre-determined distance. The system may determine one or more target POIs based on the comparison.

In some embodiments, the system may be further configured to perform one or more of the following operations. The system may determine the one or more targets POIs based on the one or more first POIs in response to a determination that the distance between the first center position and the second center position is less than or equal to the second pre-determined distance.

In some embodiments, the system may be further configured to perform one or more of the following operations. The system may determine the one or more targets POIs based on the one or more second POIs and the one or more first POIs in response to a determination that the distance between the first position and the second position is greater than or equal to the second pre-determined distance, load one or more second POIs within the first pre-determined distance from the second center position.

In some embodiments, the second pre-determined distance may be associated with a distance between the first position or the second position and a boundary of the display area of the map.

In a fourth aspect of the present disclosure, a system for points of interest (POIs) display is provided. The system may include at least one storage device and at least one processor. The at least one storage device may include a set of instructions. The at least one processor may be configured to communicate with the at least one storage device. When executing the set of instructions, the system may be configured to perform one or more of the following operations. The system may obtain a current position of a user on a display area of the map, the current position of the user being provided by the on-demand service platform associated with the client terminal. The system may designate the current position of the user as a first center position of the map. The system may load one or more first POIs within a first pre-determined distance from the first center position. The system may obtain a signal from the client terminal, the signal indicating an operation instruction for changing the display area of the map. The system may obtain a second center position of the map based on the changed display area of the map. The system may determine a distance between the first center position and the second center position. The system may compare the distance between the first center position and the second center position with a first pre-determined distance. The system may determine one or more target POIs based on the comparison. The system may cause the on-demand service platform to display at least one portion of the one or more targets POIs on the map.

In some embodiments, the system may be further configured to perform one or more of the following operations. The system may determine the one or more targets POIs based on the one or more first POIs in response to a determination that the distance between the first center position and the second center position is less than or equal to the second pre-determined distance.

In some embodiments, the system may be further configured to perform one or more of the following operations. The system may load one or more second POIs within the first pre-determined distance from the second center position in response to a determination that the distance between the first position and the second position exceeds or equals to the second pre-determined distance. The system may determine the one or more targets POIs based on the one or more second POIs and/or the one or more first POIs.

In some embodiments, the first pre-determined distance may be associated with a distance between a boundary of the display area of the map and the first center position or the second center position.

In some embodiments, the system may be further configured to perform one or more of the following operations. The system may obtain a scale associated with the changed display area of the map from the client terminal. The system may cause the on-demand service platform to display at least one portion of the one or more target POIs on the changed map based on the scale associated with the changed display area of the map.

In some embodiments, the one or more targets POIs may include at least one of an upstream station or a downstream station.

In some embodiments, the system may be further configured to perform one or more of the following operations. The system may compare the scale associated with the changed display area of the map with a first threshold and a second threshold. The system may cause the on-demand service platform to display the at least one portion of the one or more target POIs on the changed display area of the map display area based on the comparison.

In some embodiments, the system may be further configured to perform one or more of the following operations. The system may cause the on-demand service platform to display the upstream station and the downstream station on the changed display area of the map in response to a determination that the scale associated with the changed display area of the map is less than or equal to the first threshold.

In some embodiments, the system may be further configured to perform one or more of the following operations. The system may cause the on-demand service platform to display one of the upstream station and the downstream station on the changed display area of the map in response to a determination that the scale associated with the changed display area of the map exceeds or equals the first threshold and less than or equal to the second threshold.

In a fifth aspect of the present disclosure, a method for stations display is provided. The method may be implemented on at least one machine, each of which may include at least one processor and a storage device. The method may include one or more of the following operations. The method may include obtaining a scale associated with a display area of a map. The method may also include determining whether to display one or more stations on the display area of the map based on the scale associated with the display area of the map.

In a sixth aspect of the present disclosure, a method for stations display is provided. The method may be implemented on at least one machine, each of which may include at least one processor and a storage device. The method may include one or more of the following operations. The method may include obtaining a current position of a user, the current position being a first center position of a map. The method may also include loading a plurality of first stations within a first pre-determined distance from the first center position. The method may also include displaying a first sets of stations including at least one portion of the plurality of first stations within a display area of the map on the map. The method may also include receiving a signal from a client terminal, the signal including an operation instruction for changing the display area of the map. The method may also include obtaining a second center position of the map based on the changed display area of the map. The method may also include determining a distance between the first center position and the second center position. The method may also include determining whether the distance between the first center position and the second center position exceeds a second pre-determined distance. The method may also include loading a plurality of second stations within the first pre-determined distance from the second center position in response to a determination that the distance between the first center position and the second center position exceeds the second pre-determined distance. Each of the plurality of second stations may be different from one of the plurality of first stations. The method may also include displaying a second set of stations including at least one portion of the plurality of second stations within the changed display area of the map on the map.

In a seventh aspect of the present disclosure, a method for displaying points of interest (POIs) is provided. The method may be implemented on at least one machine, each of which may include at least one processor and a storage device. The method may include one or more of the following operations. The method may include obtaining a scale associated with a display area of a map from the client terminal. The scale associated with the display area of the map may be a relationship between a distance at ground and a corresponding distance on the map. The method may also include comparing the scale associated with the display area of the map with at least one of a first threshold or a second threshold. The method may also include determining whether to cause the on-demand service platform to display one or more target POIs on the map display area based on the comparison.

In an eighth aspect of the present disclosure, a method for points of interest (POIs) display is provided. The method may be implemented on at least one machine, each of which may include at least one processor and a storage device. The method may include one or more of the following operations. The method may include obtaining a current position of a user on a display area of the map. The current position of the user may be provided by a on-demand service platform associated with the client terminal. The method may also include designating the current position of the user as a first center position of the map. The method may also include loading one or more first POIs within a first pre-determined distance from the first center position. The method may also include obtaining a signal from the client terminal. The signal may indicate an operation instruction for changing the display area of the map. The method may also include obtaining a second center position of the map based on the changed display area of the map. The method may also include determining a distance between the first center position and the second center position. The method may also include comparing the distance between the first center position and the second center position with a first pre-determined distance. The method may also include determining one or more target POIs based on the comparison. The method may also include causing the on-demand service platform to display at least one portion of the one or more targets POIs on the map.

In a ninth aspect of the present disclosure, a system for stations display is provided. The system may have at least one processor and storage. The system may include an acquisition module configured to obtain a scale associated with a display area of a map. The system may also include a displaying module configured to determine whether to display one or more stations on the display area of the map based on the scale associated with the display area of the map.

In a tenth aspect of the present disclosure, a system for stations display is provided. The system may have at least one processor and storage. The system may include a position acquisition module configured to obtain a current position of a user. The current position may be a first center position of a map. The system may also include a load and display module configured to load a plurality of first stations within a first pre-determined distance from the first center position and display a first sets of stations including at least one portion of the plurality of first stations within a display area of the map on the map. The system may also include a receiving module configured to receive a signal from a client terminal, the signal including an operation instruction for changing the display area of the map. The position acquisition module may be further configured to obtain a second center position of the map based on the changed display area of the map. The system may also include a calculating module configured to determine a distance between the first center position and the second center position. The system may also include a judging module configured to determine whether the distance between the first center position and the second center position exceeds a second pre-determined distance. The load and display module may be further configured to load a plurality of second stations within the first pre-determined distance from the second center position in response to a determination that the distance between the first center position and the second center position exceeds the second pre-determined distance. Each of the plurality of second stations may be different from one of the plurality of first stations. The load and display module may be further configured to display a second set of stations including at least one portion of the plurality of second stations within the changed display area of the map on the map.

In an eleventh aspect of the present disclosure, a system for displaying points of interest (POIs) is provided. The system may have at least one processor and storage. The system may include an acquisition module configured to obtain a scale associated with a display area of a map from the client terminal. The scale associated with the display area of the map may be a relationship between a distance at ground and a corresponding distance on the map. The system may also include a judging module configured to compare the scale associated with the display area of the map with at least one of a first threshold or a second threshold. The system may also include a display module configured to determine whether to cause the on-demand service platform to display one or more target POIs on the map display area based on the comparison.

In a twelfth aspect of the present disclosure, a system for points of interest (POIs) display is provided. The system may have at least one processor and storage. The system may include an acquisition module configured to obtain a current position of a user on a display area of the map. The current position of the user may be provided by an on-demand service platform associated with the client terminal. The system may also include a POI determination module configured to designate the current position of the user as a first center position of the map, and load one or more first POIs within a first pre-determined distance from the first center position. The system may include a receiving module configured to obtain a signal from the client terminal. The signal may indicate an operation instruction for changing the display area of the map. The POI determination module may be further configured to obtain a second center position of the map based on the changed display area of the map. The system may also include a judging module configured to determine a distance between the first center position and the second center position, and compare the distance between the first center position and the second center position with a first pre-determined distance. The POI determination module may be further configured to determine one or more target POIs based on the comparison. The system may also include a display module configured to cause the on-demand service platform to display at least one portion of the one or more targets POIs on the map.

In a thirteenth aspect of the present disclosure, a non-transitory computer readable medium may comprise at least one set of instructions for stations display. The at least one set of instructions may executed by at least one processor. The at least one processor may obtain a scale associated with a display area of a map. The at least one processor may determine whether to display one or more stations on the display area of the map based on the scale associated with the display area of the map.

In a fourteenth aspect of the present disclosure, a non-transitory computer readable medium may comprise at least one set of instructions for stations display. The at least one set of instructions may executed by at least one processor. The at least one processor may obtain a current position of a user. The current position may be a first center position of a map. The at least one processor may load a plurality of first stations within a first pre-determined distance from the first center position. The at least one processor may display a first sets of stations including at least one portion of the plurality of first stations within a display area of the map on the map. The at least one processor may receiving a signal from a client terminal, the signal including an operation instruction for changing the display area of the map. The at least one processor may obtain a second center position of the map based on the changed display area of the map. The at least one processor may determine a distance between the first center position and the second center position. The at least one processor may determine whether the distance between the first center position and the second center position exceeds a second pre-determined distance. The at least one processor may load a plurality of second stations within the first pre-determined distance from the second center position in response to a determination that the distance between the first center position and the second center position exceeds the second pre-determined distance. Each of the plurality of second stations may be different from one of the plurality of first stations. The at least one processor may display a second set of stations including at least one portion of the plurality of second stations within the changed display area of the map on the map.

In a fifteenth aspect of the present disclosure, a non-transitory computer readable medium may comprise at least one set of instructions for displaying points of interest (POIs). The at least one set of instructions may executed by at least one processor. The at least one processor may obtain a scale associated with a display area of a map from the client terminal. The scale associated with the display area of the map may be a relationship between a distance at ground and a corresponding distance on the map. The at least one processor may compare the scale associated with the display area of the map with at least one of a first threshold or a second threshold. The at least one processor may determine whether to cause the on-demand service platform to display one or more target POIs (points of interest) on the map display area based on the comparison.

In a sixteenth aspect of the present disclosure, a non-transitory computer readable medium may comprise at least one set of instructions for points of interest (POIs) display. The at least one set of instructions may executed by at least one processor. The at least one processor may obtain a current position of a user on a display area of the map. The current position of the user may be provided by the on-demand service platform associated with the client terminal. The at least one processor may designate the current position of the user as a first center position of the map. The at least one processor may load one or more first POIs (points of interest) within a first pre-determined distance from the first center position. The at least one processor may obtain a signal from the client terminal. The signal may indicate an operation instruction for changing the display area of the map. The at least one processor may obtain a second center position of the map based on the changed display area of the map. The at least one processor may determine a distance between the first center position and the second center position. The at least one processor may compare the distance between the first center position and the second center position with a first pre-determined distance. The at least one processor may determine one or more target POIs (points of interest) based on the comparison. The at least one processor may cause the on-demand service platform to display at least one portion of the one or more targets POIs on the map.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online-to-offline service system according to some embodiments of the present disclosure;

FIG. 2 is a schematic diagram illustrating hardware and software components of an exemplary computing device according to some embodiments of the present disclosure;

FIG. 3 is a schematic diagram illustrating hardware and/or software components of an exemplary mobile device according to some embodiments of the present disclosure;

FIG. 4 is a block diagram illustrating an exemplary processing engine according to some embodiments of the present disclosure;

FIG. 5 is a flowchart illustrating an exemplary process for displaying a station according to some embodiments of the present disclosure;

FIG. 6 is a flowchart illustrating another exemplary process for displaying a station according to some embodiments of the present disclosure;

FIG. 7 is a flowchart illustrating another exemplary process for displaying a station according to some embodiments of the present disclosure;

FIG. 8A is a block diagram illustrating another exemplary processing engine according to some embodiments of the present disclosure;

FIG. 8B is a block diagram illustrating another exemplary processing engine according to some embodiments of the present disclosure;

FIG. 9A is a flowchart illustrating an exemplary process for loading a station according to some embodiments of the present disclosure;

FIG. 9B is a flowchart illustrating another exemplary process for loading a station according to some embodiments of the present disclosure;

FIG. 10 is a block diagram illustrating another exemplary processing engine according to some embodiments of the present disclosure;

FIG. 11 is a flowchart illustrating an exemplary process for displaying one or more target POIs according to some embodiments of the present disclosure;

FIG. 12 is a flowchart illustrating an exemplary process for loading and displaying one or more target POIs according to some embodiments of the present disclosure;

FIG. 13 is a schematic diagram of an exemplary overall display interface of a map application according to some embodiments of the present disclosure;

FIGS. 14A-14C are schematic diagrams of displaying one or more POIs on a display area of a map according to some embodiments of the present disclosure; and

FIG. 15 is a schematic diagram of a first predetermined distance and a second predetermined distance according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

It will be understood that the term “system,” “engine,” “unit,” “module,” and/or “block” used herein are one method to distinguish different components, elements, parts, section or assembly of different level in ascending order. However, the terms may be displaced by another expression if they may achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

The system or method of the present disclosure may be applied to Online-to-offline systems of different environments including land, ocean, aerospace, or the like, or any combination thereof. The vehicle of the online-to-offline systems may include a taxi, a private car, a hitch, a bus, a train, a bullet train, a high-speed rail, a subway, a vessel, an aircraft, a spaceship, a hot-air balloon, a driverless vehicle, or the like, or any combination thereof.

The term “passenger,” “requester,” “service requester,” and “customer” in the present disclosure are used interchangeably to refer to an individual, an entity or a tool that may request or order a service. The term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger,” “user equipment,” “user terminal,” and “passenger terminal” may be used interchangeably, and “driver” and “driver terminal” may be used interchangeably.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The present disclosure relates to systems and methods for station display. The system may obtain a scale associated with a display area of a map and determine whether to display one or more stations on the display area of the map based on the scale associated with the display area of the map. The one or more stations may include an upstream station and a downstream station. The system may compare the scale associated with the display area of the map with a first threshold and a second threshold. The system may display the upstream station and the downstream station on the display area of the map if the scale associated with the display area of the map is less than or equal to the first threshold. The system may display the upstream station or the downstream station on the display area of the map if the scale associated with the display area of the map exceeds the first threshold and is less than or equal to a second threshold. The system may display neither the upstream station nor the downstream station on the display area of the map if the scale associated with the display area of the map is greater than the second threshold.

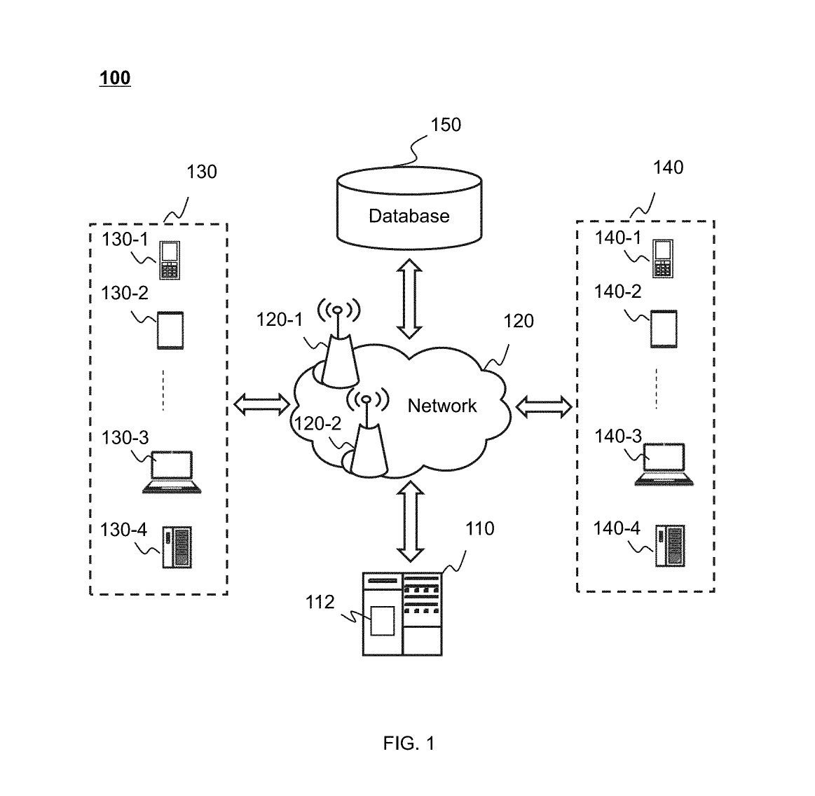

FIG. 1 is a schematic diagram illustrating an exemplary online-to-offline service system 100 according to some embodiments of the present disclosure. The online-to-offline service system 100 may include a server 110, a network 120, a service requester terminal 130, a service provider terminal 140, and a storage 150.

For example, the online-to-offline service system 100 may be an online transportation service platform for transportation services. The transportation services may include but not limited to car-hailing service, chauffeur service, express car service, carpool service, bus service, driver hire service, or shuttle service. In some embodiments, the online-to-offline service system 100 may provide other types of services including but not limited to a delivery service, a navigation service, a booking service, a shopping service, an inquiry service, or the like, or any combination thereof.

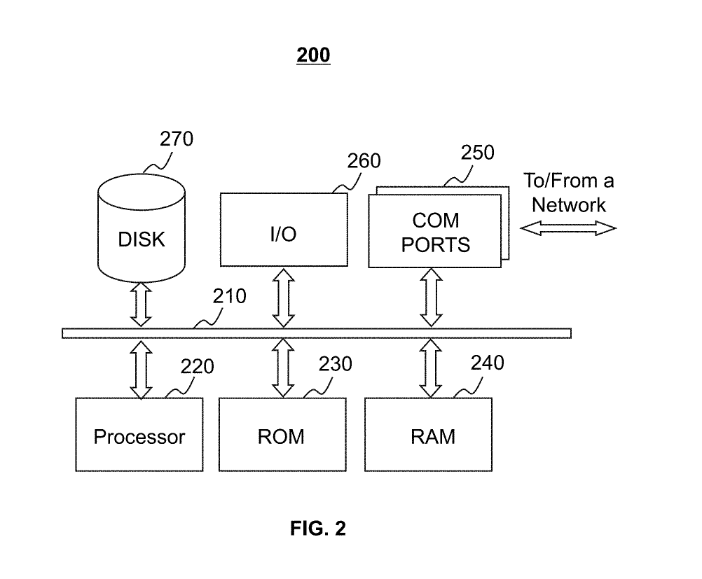

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the service requester terminal 130, the service provider terminal 140, and/or the storage 150 via the network 120. As another example, the server 110 may be directly connected to the service requester terminal 130, the service provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the POI and/or a display area of the map to perform one or more functions described in the present disclosure. For example, the processing engine 112 may obtain a scale associated with the display area of the map from a client terminal (e.g., the service requester terminal 130, the service provider terminal 140). The processing engine 112 may compare the scale associated with the display area of the map with at least one of a first threshold or a second threshold. The processing engine 112 may determine whether to display one or more target POIs (e.g., stations) on the map display area based on the comparison. As another example, the processing engine 112 may obtain a current position of a user on the display area of the map and designate the current position of the user as a first center position of the map. The processing engine 112 may load one or more first POIs (e.g., stations) within a first pre-determined distance from the first center position. The processing engine 112 may also obtain a signal from the client terminal, the signal indicating an operation instruction for changing the display area of the map, and obtain a second center position of the map based on the changed display area of the map. The processing engine 112 may further determine a distance between the first center position and the second center position compare the distance between the first center position and the second center position with a first pre-determined distance. The processing engine 112 may determine one or more target POIs (e.g., stations) based on the comparison. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof. In some embodiments, the processing engine 112 may realize one or more functions described in the present disclosure by logic circuits thereof.

The network 120 may facilitate exchange of information and/or data. In some embodiments, one or more components of the online-to-offline service system 100 (e.g., the server 110, the service requester terminal 130, the service provider terminal 140, and the storage 150) may transmit information and/or data to other component(s) of the online-to-offline service system 100 via the network 120. For example, the processing engine 112 may obtain the scale associated with a display area of the map from a client terminal (e.g., the service requester terminal 130, the service provider terminal 140) via the network 120. As another example, the processing engine 112 may obtain signals/instructions indicating changing the display area of the map from a client terminal (e.g., the service requester terminal 130, the service provider terminal 140) via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online-to-offline service system 100 may be connected to the network 120 to exchange data and/or information.

In some embodiments, a passenger may be an owner of the service requester terminal 130. In some embodiments, the owner of the service requester terminal 130 may be someone other than the passenger. For example, an owner A of the service requester terminal 130 may use the service requester terminal 130 to transmit a service request for a passenger B or receive a service confirmation and/or information or instructions from the server 110. In some embodiments, a service provider may be a user of the service provider terminal 140. In some embodiments, the user of the service provider terminal 140 may be someone other than the service provider. For example, a user C of the service provider terminal 140 may use the service provider terminal 140 to receive a service request for a service provider D, and/or information or instructions from the server 110. In some embodiments, “passenger” and “passenger terminal” may be used interchangeably, and “service provider” and “service provider terminal” may be used interchangeably.

In some embodiments, the service requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smartwatch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the service requester terminal 130 may be a device with positioning technology (e.g., through a global positioning system (GPS) chipset) for locating the position of the passenger and/or the service requester terminal 130.

The service provider terminal 140 may include a plurality of service provider terminals 140-1, 140-2, . . . , 140-n. In some embodiments, the service provider terminal 140 may be similar to, or the same as the service requester terminal 130. In some embodiments, the service provider terminal 140 may be customized to be able to implement the online-to-offline transportation service. In some embodiments, the service provider terminal 140 may be a device with positioning technology (e.g., through a global positioning system (GPS) chipset) for locating the service provider and/or the service provider terminal 140. In some embodiments, the service requester terminal 130 and/or the service provider terminal 140 may communicate with another positioning device to determine the position of the passenger, the service requester terminal 130, the service provider, and/or the service provider terminal 140. In some embodiments, the service requester terminal 130 and/or the service provider terminal 140 may periodically transmit data and/or information related to load and display the one or more POIs to the server 110 via a user interface. The user interface may be implemented on the service requester terminal 130 and/or the service provider terminal 140 in form of an application (e.g., an online to offline service application). The user interface may facilitate a communication between a user, the service requester terminal 130 and/or the service provider terminal 140, and the service 110. For example, the service requester terminal 130 and/or the service provider terminal 140 may transmit a signal including the position information associated with the user to the server 110 via the user interface. As another example, the service requester terminal 130 and/or the service provider terminal 140 may transmit a signal including the scale associated with the display area of the map to the server 110 in response to an operation on the display area of the map inputted by the user via the user interface. As a further example, the service requester terminal 130 and/or the service provider terminal 140 may receive a signal including one or more target POIs from the server 110 via the user interface. The signal may be also configured to cause the service requester terminal 130 and/or the service provider terminal 140 to display the one or more target POIs for the user.

In some embodiments, the server 110 may transmit a connection request to the terminal (e.g., the service requester terminal 130 and/or the service provider terminal 140) and establish a connection with the terminal after the connection request is accepted by the terminal. In some embodiments, the terminal may transmit a connection request to the server and establish a connection with the server after the connection request is accepted by the server. It should be noted that the communication between the server and the terminal may refer to direct communication between them or communication between the applications installed on them.

The storage 150 may store data and/or instructions. In some embodiments, the storage 150 may store data obtained from the service requester terminal 130 and/or the service provider terminal 140. For example, the storage 150 may store one or more target stations determined by the server 110. In some embodiments, the storage 150 may store data and/or instructions that the server 110 may execute or use to perform exemplary methods described in the present disclosure. In some embodiments, storage 150 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include random-access memory (RAM). Exemplary RAM may include a dynamic RAM (DRAM), a double data rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the online-to-offline service system 100 (e.g., the server 110, the service requester terminal 130, or the service provider terminal 140). One or more components of the online-to-offline service system 100 may access the data or instructions stored in the storage 150 via the network 120. In some embodiments, the storage 150 may be directly connected to or communicate with one or more components of the online-to-offline service system 100 (e.g., the server 110, the service requester terminal 130, the service provider terminal 140). In some embodiments, the storage 150 may be part of the server 110.

In some embodiments, one or more components of the online-to-offline service system 100 (e.g., the server 110, the service requester terminal 130, the service provider terminal 140) may have permissions to access the storage 150. In some embodiments, one or more components of the online-to-offline service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components of the online-to-offline service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in the software of a mobile terminal, a program, a system, or the like, or any combination thereof. The mobile terminal may include a tablet computer, a laptop computer, a mobile phone, a personal digital assistant (PDA), a smartwatch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the service requester terminal 130, and/or the service provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a special purpose computer in some embodiments. The computing device 200 may be used to implement an online-to-offline service system for the present disclosure. The computing device 200 may implement any component of the online-to-offline service as described herein. In FIGS. 1-2, only one such computer device is shown purely for convenience purposes. One of ordinary skill in the art would understand that the computer functions relating to the online-to-offline service as described herein may be implemented in a distributed fashion on a number of similar platforms, to distribute the processing load.

The computing device 200, for example, may include COMM ports 250 connected to and from a network (e.g., the network 120) connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU 220. The methods and/or processes of the present disclosure may be implemented as the program instructions. The computing device 200 also includes an I/O 260, supporting input/output between the computer and other components therein. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, the CPU and/or processor of the computing device 200 executes both step A and step B. As in another example, step A and step B may also be performed by two different CPUs and/or processors jointly or separately in the computing device 200 (e.g., the first processor executes step A, and the second processor executes step B; or the first and second processors jointly execute steps A and B).

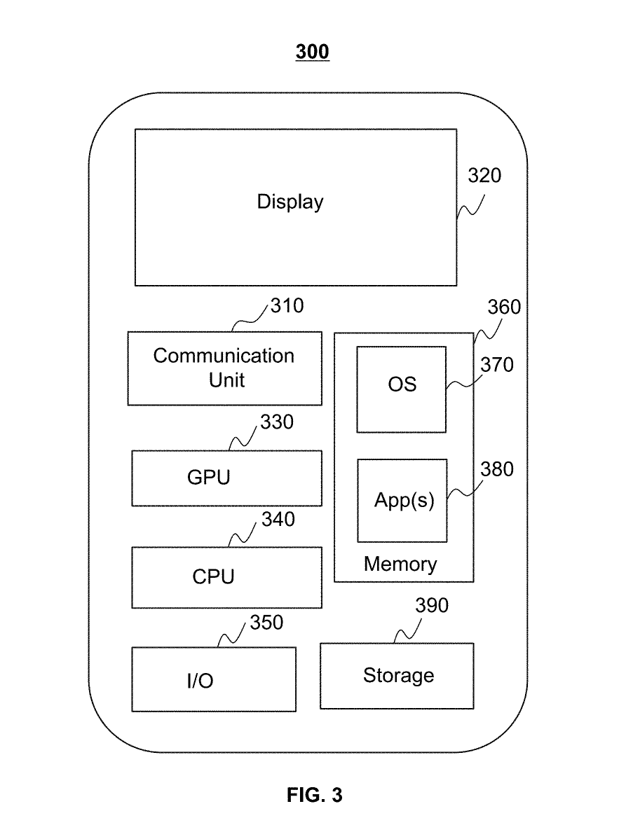

FIG. 3 is a schematic diagram illustrating exemplary hardware and/or software components of an exemplary mobile device 300 on which a user terminal may be implemented according to some embodiments of the present disclosure. As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to Online-to-offline service or other information from the processing engine 112. User interactions with the information stream may be achieved via the I/O 350 and provided to the processing engine 112 and/or other components of the online-to-offline service system 100 via the network 120. In some embodiments, the mobile device 300 may transmit (or receive) a connection request to the server 110 via a network 120 and establish a connection with the server 110 after the connection request is accepted by the server 110 (or the mobile device 300). After the connection between the server 110 and the mobile device 300 is established, the server 110 may communicate with the application(s) 380 installed on the mobile device 300 to transmit or receive information or data (e.g., service request, information of service provider or service requester, position information, etc.). In some embodiments, the application(s) 380 may be an online to offline service application (e.g., a taxi-hailing app, a map app, etc.).

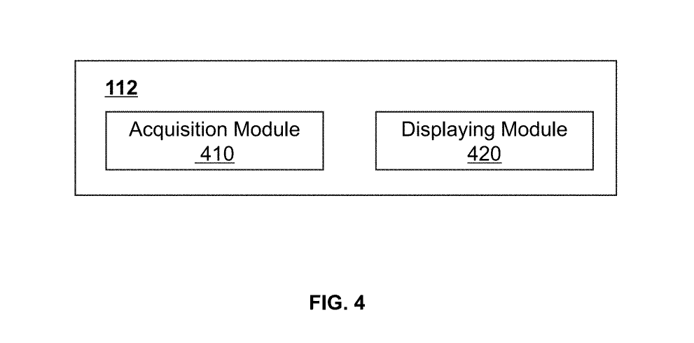

FIG. 4 is a block diagram illustrating an exemplary processing engine 112 according to some embodiments of the present disclosure. The processing engine 112 may include an acquisition module 410 and a displaying module 420. Each of the modules described above may be a hardware circuit that is designed to perform certain actions, e.g., according to a set of instructions stored in one or more storage media, and/or any combination of the hardware circuit and the one or more storage media.

The acquisition module 410 may be configured to obtain the scale associated with the display area of a map. As used herein, the scale associated with the display area of a map may denote a relationship between a distance at ground (also referred to as actual distance) and a corresponding distance on the map (also referred to as map distance). In some embodiments, the scale associated with the display area of the map may be equal to a ratio of the actual distance to the map distance. In some embodiments, the acquisition module 410 may obtain the scale associated with the display area of the map from a client terminal (e.g., the service requester terminal 130, the service provider terminal 140) via the network 120. For example, a user associated with the client terminal may input the scale associated with the display area of the map via a user interface implemented on the client terminal. As another example, the user may zoom in or out the display area via the user interface, and the acquisition module 410 may determine the scale associated with the display area of the map based on the operation of the user.

The displaying module 420 may be configured to determine whether to display one or more stations on the display area of the map based on the scale associated with the display area of the map. In some embodiments, the one or more stations may include at least one upstream station and/or downstream station. Further, the displaying module 420 may determine whether to display an upstream station and/or a downstream station on the map within the display area. As used herein, an upstream station may refer to a station on a travel route from a start point to a destination. A downstream station may refer to a station on another travel route from the destination to the start point. According to the scale associated with the display area of the map, the displaying module 420 may perform one of displaying an upstream station and a downstream station on the display area of the map, displaying an upstream station or a downstream station on the display area of the map, and displaying neither an upstream station nor a downstream station on the display area of the map. In some embodiments, the displaying module 420 may display an upstream station or a downstream station on the display area of the map based on the setting of the user.

It should be noted that the above descriptions of the processing engine 112 is provided for the purposes of illustration, and not intended to limit the scope of the present disclosure. For a person having ordinary skill in the art, various modifications and changes in the forms and details of the application of the above method and system may occur without departing from the principles of the present disclosure. However, those variations and modifications also fall within the scope of the present disclosure. In some embodiments, the processing engine 112 may include one or more other modules. For example, the processing engine 112 may include a storage module to store data generated by the modules in the processing engine 112. In some embodiments, any two of the modules may be combined as a single module, and any one of the modules may be divided into two or more units.

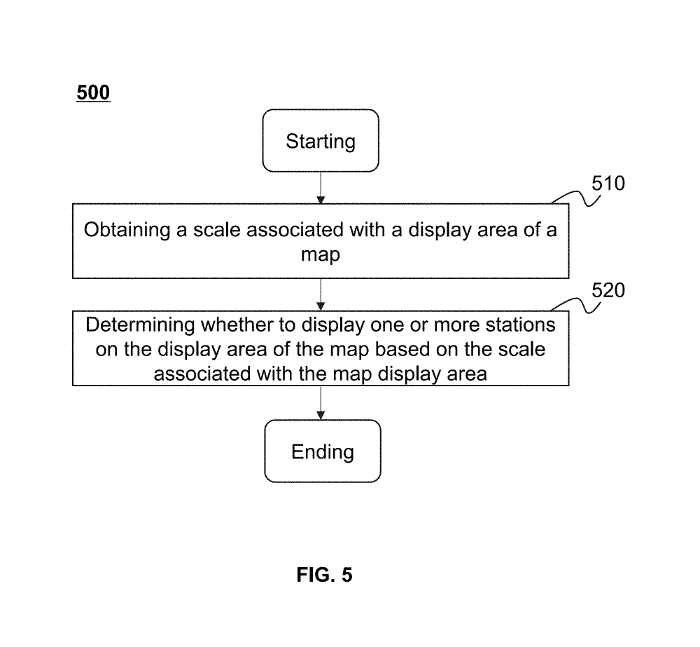

FIG. 5 is a flowchart illustrating an exemplary process for displaying a station according to some embodiments of the present disclosure. In some embodiments, process 500 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 500. The operations of the illustrated process present below are intended to be illustrative. In some embodiments, process 500 may be accomplished with one or more additional operations not described and/or without one or more of the operations herein discussed. Additionally, the order in which the operations of the process as illustrated in FIG. 5 and described below is not intended to be limiting.

In 510, the processing engine 112 may obtain a scale associated with a display area of a map.

As used herein, the scale associated with the display area of a map may denote a relationship between a distance at ground (also referred to as actual distance) and a corresponding distance on the map (also referred to as map distance). In some embodiments, the scale associated with the display area of the map may be equal to a ratio of the actual distance to the map distance. In some embodiments, the processing engine 112 may obtain the scale associated with the display area of the map from a client terminal (e.g., the service requester terminal 130, the service provider terminal 140) via the network 120. For example, a user associated with the client terminal may input the scale associated with the display area of the map via a user interface implemented on the client terminal. As another example, the user may zoom in or out the display area via the user interface, and the processing engine 112 may determine the scale associated with the display area of the map based on the operation of the user.

In 520, the processing engine 112 may determine whether to display one or more stations on the display area of the map based on the scale associated with the display area of the map.

In some embodiments, when a user launches a map application from an electronic device, the processing engine 112 may locate the current position of the user, and request to access a station interface (e.g., a station database) to obtain a plurality of stations within a predetermined range centered on the current position of the user. For example, the processing engine 112 may obtain the plurality of stations within 1 km centered on the current position of the user. The processing engine 112 may further determine whether to display at least one portion of the plurality of stations based on the scale associated with the display area of the map. The processing engine 112 may display at least one portion of the plurality of stations when the user needs, and hide at least one portion the plurality of stations when the user does not need, which may meet the demand of the user to view one or more stations. The plurality of stations may be displayed on map via the map application implemented in the electronic device based on the scale associated with the display area of the map, which may also avoid multiple stations overlapped on the map. And the confusion of elements on the map and visual interference between multiple stations displayed on the map caused by the overlapped stations may be avoided.

In some embodiments, the one or more stations may include at least one upstream station and/or downstream station. Further, the processing engine 112 may determine whether to display an upstream station and/or a downstream station on the map within the display area based on the scale associated with the display area of the map. For example, the processing engine 112 may determine to display at least one of the upstream station or the downstream station on the display area of the map. As another example, the processing engine 112 may determine to display neither the upstream station nor the downstream station on the display area of the map. As used herein, an upstream station may refer to a station on a travel route from a start point to a destination. A downstream station may refer to a station on another travel route from the destination to the start point.

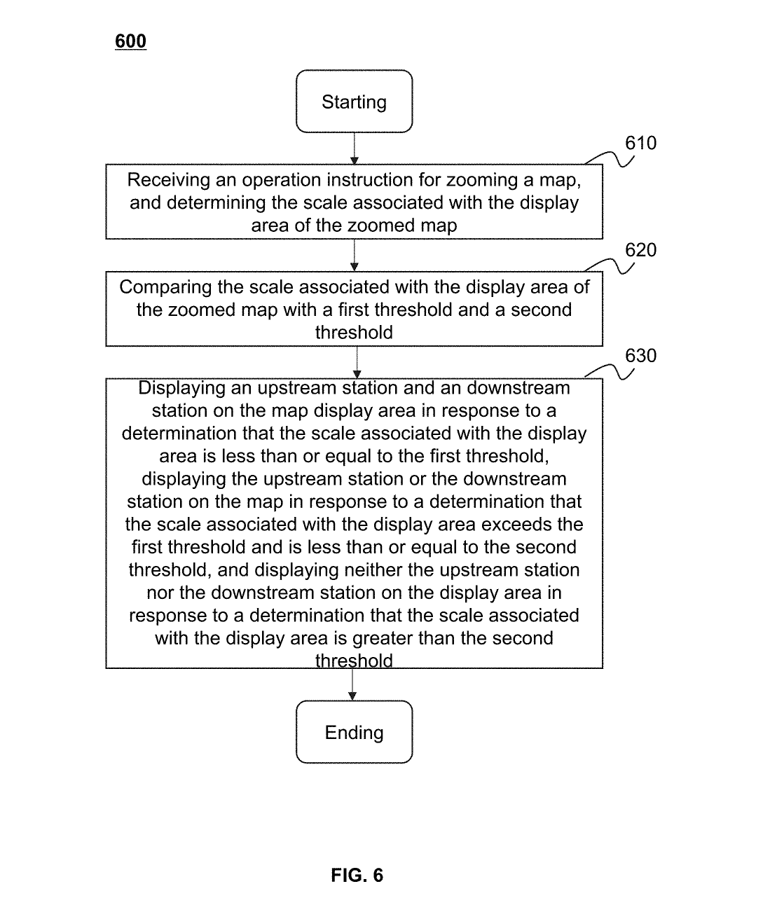

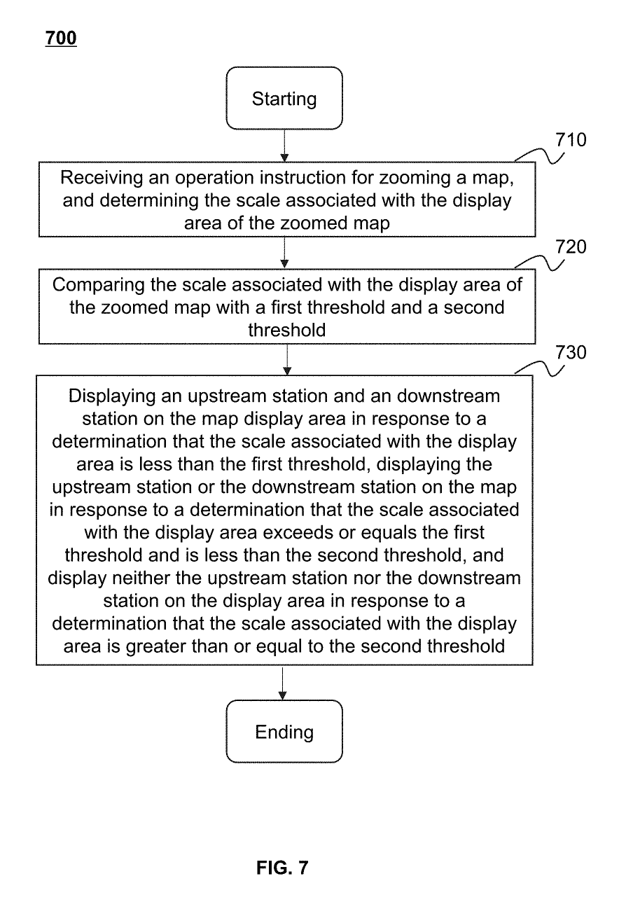

According to the scale associated with the display area of the map, the processing engine 112 may perform one of displaying an upstream station and a downstream station on the display area of the map, displaying an upstream station or a downstream station on the display area of the map, and displaying neither an upstream station nor a downstream station on the display area of the map. Further, the processing engine 112 may determine to display an upstream station or a downstream station on the display area of the map based on the setting of the user. For example, if the travel route associated with the user is from the starting point to the destination, the processing engine 112 may determine to display an upstream station on the display area of the map. If the travel route associated with the user is from the destination to the starting point, the processing engine 112 may determine to display a downstream station on the display area of the map. In this way, all stations within a predetermined range centered on the current position of the user may be displayed when the user needs, and all or a part of the stations within the predetermined range centered on the current position of the user may be hided when the user does not need. One or more stations may be displayed on the map based on the scale associated with the display area of the map, which may avoid intensive stations covering the map information when multiple stations are displayed on the map and the scale associated with the display area of the map is relatively high. Detailed descriptions may refer to FIGS. 6-7, and descriptions thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, process 500 may further include display the one or more stations based on the determination in operation 520. For example, the processing engine 112 may display an upstream station and/or a downstream station on the map within the display area based on the scale associated with the display area of the map.

FIG. 6 is a flowchart illustrating another exemplary process for displaying a station according to some embodiments of the present disclosure. In some embodiments, process 600 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 600. The operations of the illustrated process present below are intended to be illustrative. In some embodiments, process 600 may be accomplished with one or more additional operations not described and/or without one or more of the operations herein discussed. Additionally, the order in which the operations of the process as illustrated in FIG. 6 and described below is not intended to be limiting.

In 610, the processing engine 112 may receive an operation instruction for zooming a map, and obtain a scale associated with the display area of the zoomed map. In some embodiments, the processing engine 112 may obtain the scale associated with the display area from a client terminal (e.g., the service requester terminal 130, the service provider terminal 140) via the network 120 as described in connection with operation 510 illustrated in FIG. 5. In some embodiments, if the scale associated with the display area of the zoomed map is equal to 10, a map distance of 1 centimeter is equal to an actual distance of 10 meters. If the scale associated with the display area of the zoomed map is equal to 100, a map distance of 1 centimeter is equal to an actual distance of 100 meters. It should be noted that the unit of the actual distance is meter, and the unit of the map distance is centimeter. In some embodiments, the unit of the actual distance and the unit of the map distance may be unified, and the value of the first threshold and the second threshold may be changed accordingly.

In 620, the processing engine 112 may compare the scale associated with the display area of the zoomed map with a first threshold and a second threshold. In some embodiments, the first threshold may be 10, and the second threshold may be 100. By determining whether to display or hide stations on the display area of the map, different display modes of the stations under different scales associated with the display area of the map may be realized as described in connection with operations 630 or 730.

In 630, the processing engine 112 may display an upstream station and a downstream station on the map in response to a determination that the scale associated with the display area of the zoomed map is less than or equal to the first threshold. The processing engine 112 may display an upstream station or a downstream station on the map in response to a determination that the scale associated with the display area of the zoomed map is greater than the first threshold and is less than or equal to the second threshold. The processing engine 112 may display neither an upstream station nor a downstream station on the map in response to a determination that the scale associated with the display area of the zoomed map is greater than the second threshold.

FIG. 7 is a flowchart illustrating another exemplary process for displaying a station according to some embodiments of the present disclosure. In some embodiments, process 700 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 700. The operations of the illustrated process present below are intended to be illustrative. In some embodiments, process 700 may be accomplished with one or more additional operations not described and/or without one or more of the operations herein discussed. Additionally, the order in which the operations of the process as illustrated in FIG. 7 and described below is not intended to be limiting.

In 710, the processing engine 112 may receive an operation instruction for zooming a map, and obtain a scale associated with the display area of the zoomed map. In some embodiments, the processing engine 112 may obtain the scale associated with the display area from a client terminal (e.g., the service requester terminal 130, the service provider terminal 140) via the network 120 as described in connection with operation 510 illustrated in FIG. 5.

In 720, the processing engine 112 may compare the scale associated with the display area of the zoomed map with a first threshold and a second threshold.

In 730, the processing engine 112 may display an upstream station and a downstream station on the map in response to a determination that the scale associated with the display area of the zoomed map is less than the first threshold. The processing engine 112 may display an upstream station or a downstream station on the map in response to a determination that the scale associated with the display area of the zoomed map is greater than or equal to the first threshold and is less than the second threshold. The processing engine 112 may display neither an upstream station nor a downstream station on the map in response to a determination that the scale associated with the display area of the zoomed map is greater than or equal to the second threshold.

In some embodiments, a scale associated with the display area of the map may be changed after the user zooms the map. According to the changed scale associated with the display area of the map caused by the user zooming the map, the processing engine 112 may determine to display an upstream station and/or a downstream station, or display neither an upstream station nor a downstream station, which may be convenient for the user to view one or more stations. The processing engine 112 may determine the range that the changed scale associated with the display area of the zoomed map belongs. Further, the processing engine 112 may determine whether to display the upstream station and/or the downstream station based on the range that the changed scale associated with the display area of the zoomed map belongs. The processing engine 112 may determine whether to display one or more stations when the user needs or hide one or more stations when the user does not need by comparing the changed scale associated with the display area of the zoomed map with at least one threshold (e.g., the first threshold, the second threshold, etc.). In this way, the system 100 may ensure the demands of users while avoiding overlapping stations on the map.

In some embodiments, the first threshold may be 10, and the second threshold may be 100.

In some embodiments, if the scale associated with the display area of the zoomed map is equal to 10, a map distance of 1 centimeter is equal to an actual distance of 10 meters. If the scale associated with the display area of the zoomed map is equal to 100, a map distance 1 centimeter is equal to an actual distance of 100 meters. It should be noted that the unit of the actual distance is meters, and the unit of the map distance is centimeters. In some embodiments, the unit of the actual distance and the unit of the map distance may be unified, and the value of the actual distance or the map distance may be changed accordingly.

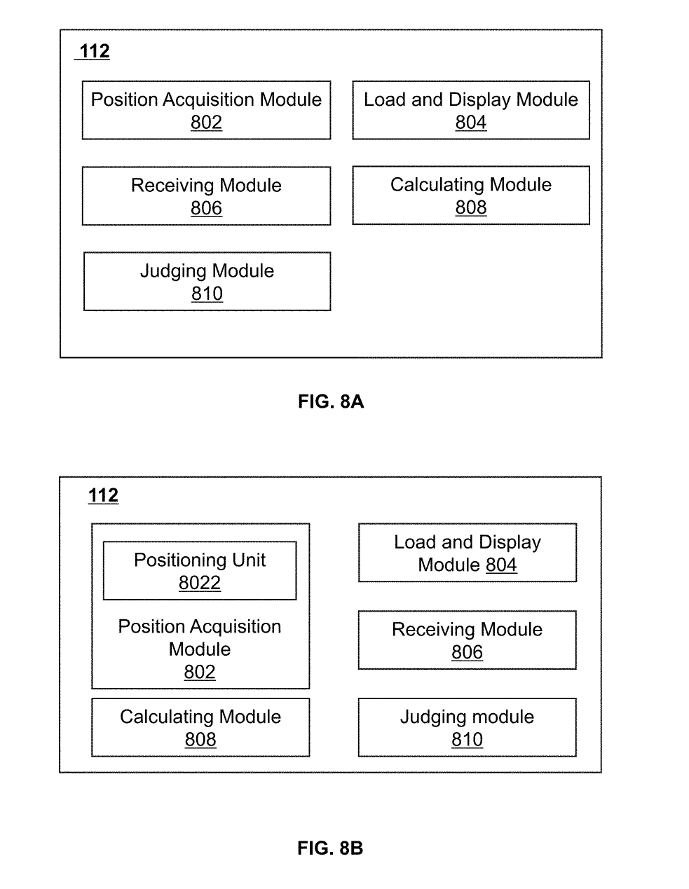

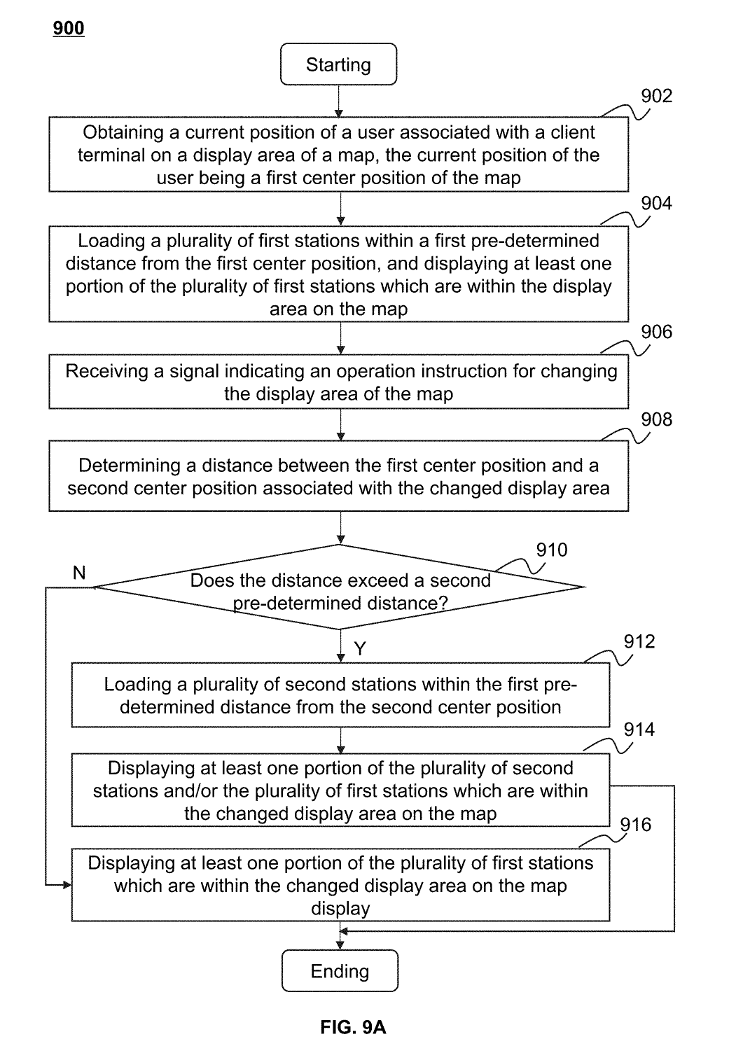

FIG. 8A is a block diagram illustrating another exemplary processing engine 112 according to some embodiments of the present disclosure. The processing engine 112 may include a position acquisition module 802, a load and display module 804, a receiving module 806, a calculating module 808, and a judging module 810. Each of the modules described above may be a hardware circuit that is designed to perform certain actions, e.g., according to a set of instructions stored in one or more storage media, and/or any combination of the hardware circuit and the one or more storage media.

The position acquisition module 802 may be configured to obtain a current position of a user. The position acquisition module 802 may designate the current position of the user as a first center position of a map. As used herein, the current position of the user may be a geographic location of the user. The geographic location of the user may be associated with and obtained from a client terminal carried by the user. For example, the processing engine 112 may obtain the geographic location of the user based on the position information of the client terminal that is determined by a positioning chipset of the client terminal. As another example, the geographic location of the user may be inputted by the user via the user interface of the client terminal (e.g., a map application). The center position of a map may refer to a location on the map corresponding to a geometric center of the display area of the map.

The position acquisition module 802 may also be configured to obtain a second center position of the map when the display area of the map is changed. In some embodiments, the display area of the map may be changed when the user drags the map. The position acquisition module 802 may determine the changed display area of the map in response to the operation instruction for dragging the map from a client terminal carried by the user. The position acquisition module 802 may designate a center position of the changed display area of the map as the second center position.

The load and display module 804 may be configured to load a plurality of first stations within a first predetermined distance from the first center position. The load and display module 804 may then display a first set of stations on a display area of the map. The first set of stations may include at least one portion of the plurality of first stations within the display area of the map. The load and display module 804 may be configured to load a plurality of second stations within the first predetermined distance from a second center position of the changed displayed area of the map if the distance between the first center position and the second center position exceeds a second predetermined distance. The load and display module 804 may then display a second set of stations on the changed display area of the map. The second set of stations may include at least one portion of the plurality of first stations and at least one position of the plurality of second stations within the changed display area of the map. The load and display module 804 may be configured to display a third set of stations on the changed display area of the map if the distance between the first center position and the second center position is less than or equal to the second predetermined distance. The third set of stations may include at least one portion of the plurality of first stations within the changed display area of the map.

The receiving module 806 may be configured to receive a signal from a client terminal. The signal may indicate an operation instruction for changing the display area of the map. The processing engine 112 may cause the client terminal (e.g., the map application) to change the display area of the map according to the operation instruction. In some embodiments, the operation instruction for changing the display area of the map may be generated by the user dragging the map via the user interface (e.g., a map application) of the client terminal.

The calculating module 808 may be configured to determine a distance between the first center position and the second center position. In some embodiments, the distance between the first center position and the second center position may be a map distance between the first center position and the second center position. In some embodiments, the distance between the first center position and the second center position may be an actual distance corresponding to the map distance between the first center position and the second center position according to a scale associated with the display area of the map.

The judging module 810 may be configured to determine whether the distance between the first center position and the second center position exceeds a second predetermined distance.

FIG. 8B is a block diagram illustrating another exemplary processing engine 112 according to some embodiments of the present disclosure. The processing engine 112 may include a position acquisition module 802, a load and display module 804, a receiving module 806, a calculating module 808, and a judging module 810. Each of the modules described above may be a hardware circuit that is designed to perform certain actions, e.g., according to a set of instructions stored in one or more storage media, and/or any combination of the hardware circuit and the one or more storage media.

The position acquisition module 802 may further include a positioning unit 8022. The positioning unit 8022 may be configured to position a current city where the user locates. The position acquisition module 802 may obtain the current position of the user based on the position of the current city. More descriptions of the position acquisition module 802, the load and display module 804, the receiving module 806, the calculating module 808, and the judging module 810 may be found in FIG. 8A.

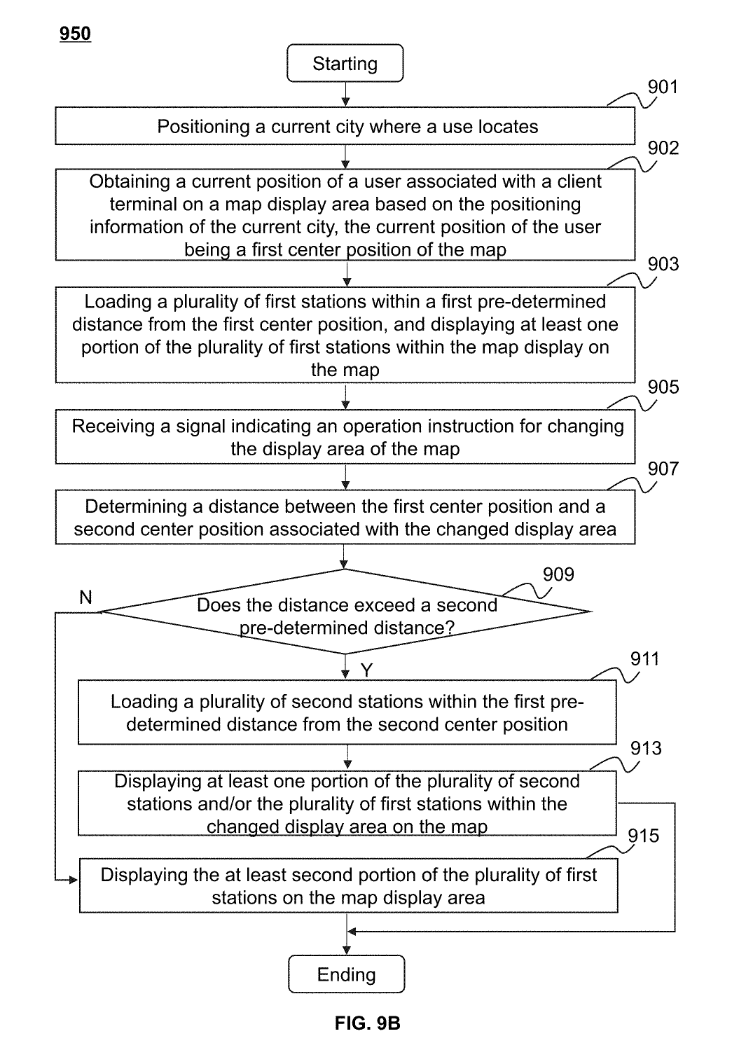

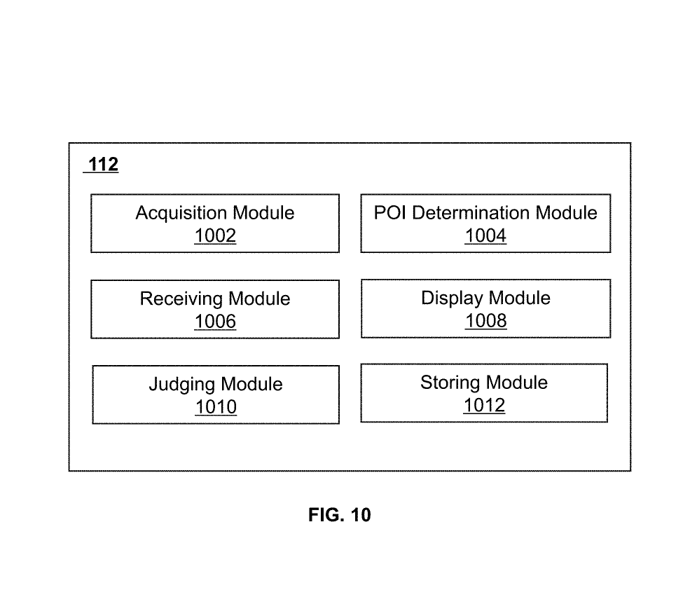

FIG. 9A is a flowchart illustrating an exemplary process for loading a station according to some embodiments of the present disclosure. In some embodiments, process 900 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 900. The operations of the illustrated process present below are intended to be illustrative. In some embodiments, process 900 may be accomplished with one or more additional operations not described and/or without one or more of the operations herein discussed. Additionally, the order in which the operations of the process as illustrated in FIG. 9A and described below is not intended to be limiting.

In 902, the processing engine 112 may obtain a current position of a user. The processing engine 112 may designate the current position of the user as a first center position of a map. As used herein, the current position of the user may be a geographic location of the user. The geographic location of the user may be associated with and obtained from a client terminal carried by the user. For example, the processing engine 112 may obtain the geographic location of the user based on the position information of the client terminal that is determined by a positioning chipset of the client terminal. As another example, the geographic location of the user may be inputted by the user via the user interface of the client terminal (e.g., a map application). The center position of a map may refer to a location on the map corresponding to a geometric center of the display area of the map. If the display area of the map changes, the geometric center of the display area of the map may not change. But the location corresponding to the geometric center of the changed display area of the map may change.

In 904, the processing engine 112 may load a plurality of first stations within a first predetermined distance from the first center position. In some embodiments, the processing engine 112 may display at least one portion of the plurality of first stations which are within the display area on the map. The at least one portion of the plurality of first stations within the display area of the map may also be referred to as a first set of stations.

In 906, the processing engine 112 may receive a signal including an operation instruction for changing the display area of the map from a client terminal. The processing engine 112 may cause the client terminal (e.g., the map application) to change the display area of the map according to the operation instruction. In some embodiments, the operation instruction for changing the display area of the map may be generated by the user dragging and/or moving the map via the user interface (e.g., a map application) of the client terminal.

In 908, the processing engine 112 may determine a distance between the first center position and a second center position associated with the changed display area of the map. After the user drags the map, the processing engine 112 may determine the changed display area of the map upon receiving the signal including the operation instruction for changing the display area of the map. The processing engine 112 may designate a location corresponding to the geometric center of the changed display area of the map as the second center position.

In 910, the processing engine 112 may determine whether the distance between the first center position and the second center position exceeds a second predetermined distance. If the distance between the first center position and the second center position exceeds the second predetermined distance, process 900 may proceed to perform operation 912. If the distance between the first center position and the second center position is less than or equal to the second predetermined distance, process 900 may proceed to perform operation 916.

In 912, the processing engine 112 may load a plurality of second stations within the first predetermined distance from the second center position in response to a determination that the distance between the first center position and the second center position exceeds the second predetermined distance. Each of the plurality of second stations may be different from one of the plurality of first stations. In other words, one or more stations of the plurality of first stations loaded in operation 904 within the first predetermined distance from the second center position may be not loaded once again.

In 914, the processing engine 112 may display at least one portion of the plurality of second stations and/or at least one portion of the plurality of first stations which are within the changed display area on the map. The at least one portion of the plurality of second stations and/or at least one portion of the plurality of first stations within the changed display area of the map may be also referred to as a second set of stations.

In 916, the processing engine 112 may display at least one portion of the plurality of first stations which are within the changed display area on the map in response to a determination that the distance between the first center position and the second center position is less than or equal to the second predetermined distance. The at least one portion of the plurality of first stations within the changed display area of the map may also be referred to as a third set of stations. In some embodiments, the third set of stations may be same as the first set of stations. In some embodiments, one portion of the third set of stations may be same as the first set of stations.

Specifically, when a user launches a map application from an electronic device, the processing engine 112 may locate the current position of the user (i.e., the first center position of the display area of a map), and request to access a station interface (e.g., a station database) to obtain the plurality of first stations within the first predetermined distance from the current position of the user (i.e., the first center position of the display area of the map). A station may include a bus station, a subway station, etc. As used herein, the display area of a map may refer to a visible region of the map. The processing engine 112 may display all or part of the plurality of first stations (i.e., the first set of stations) which are within the display area of the map on the map. After the user changes the display area of the map by dragging and/or moving the map, the processing engine 112 may determine the distance between the first center position and the second center position of the changed display area of the map. If the distance between the first center position and the second center position exceeds the second predetermined distance, the processing engine 112 may determine that a range within the first predetermined distance from the second center position exceeds a range within the first predetermined distance from the first center position, in where the plurality of first stations have been loaded. The processing engine 112 may re-request to access the station interface (e.g., a station database) to load a plurality of second stations within the first predetermined distance from the second center position. The plurality of second stations may be not loaded when the processing engine 112 loads the plurality of first stations within the first predetermined distance from the first center position. The processing engine 112 may display at least one portion of the plurality of second stations and/or at least one portion of the plurality of first stations (i.e., the second set of stations) which are within the changed display area of the map on the map by a display screen of the client terminal. In some embodiments, the second set of stations may include at least one portion of the plurality of first stations and at least one portion of the plurality of second stations within the changed display area of the map. In some embodiments, the second set of stations may only include at least one portion of the plurality of second stations within the changed display area of the map. By loading only the unloaded stations within the predetermined distance from a center position of the display area of the map at a time, the network flow of the client terminal consuming may be reduced, while the mapping consistency between stations displayed on the display area of the map (e.g., the visible area of the map) and the corresponding stations located at the actual road and the fluency for displaying the stations may be ensured.

If the distance between the first center position and the second center position is less than or equal to the second predetermined distance, the processing engine 112 may determine that the range within the first predetermined distance from the second center position does not exceed the range within the first predetermined distance from the first center position in where the plurality of first stations have been loaded. The processing engine 112 may not re-request to access the station interface (e.g., a station database) to load the plurality of second stations within the first predetermined distance from the second center position. The processing engine 112 may display at least one portion of the plurality of loaded first stations (also referred to as a third set of stations) which are within the changed display area of the map, which may save the network flow of the client terminal consuming, and improve the speed for display.

Each time the user drags and/or moves the map (i.e. changes the display area of the map), the processing engine 112 may determine a distance between a current center position and the last center position of the display area of the map for loading stations. The processing engine 112 may display one or more stations according to a comparison between the distance and at least one predetermined threshold (e.g., the second predetermined distance). The processing engine 112 may display at least one portion of a plurality of stations (e.g., a bus stop, a subway station, etc.) near the current position of the, and not re-load a plurality of stations (e.g., the plurality of second stations) when the user drags and/or moves the map in a small range, which may ensure the smoothness of user experience and the integrity of the information or data on the map. By setting at least one predetermined threshold (e.g., the second predetermined distance, etc.), when the user drags or moves the map beyond the predetermined threshold, the processing engine 112 may re-load one or more stations (e.g., the plurality of second stations) to ensure that one or more stations displayed on the display area of the map is consistent with the corresponding stations located at the actual road.

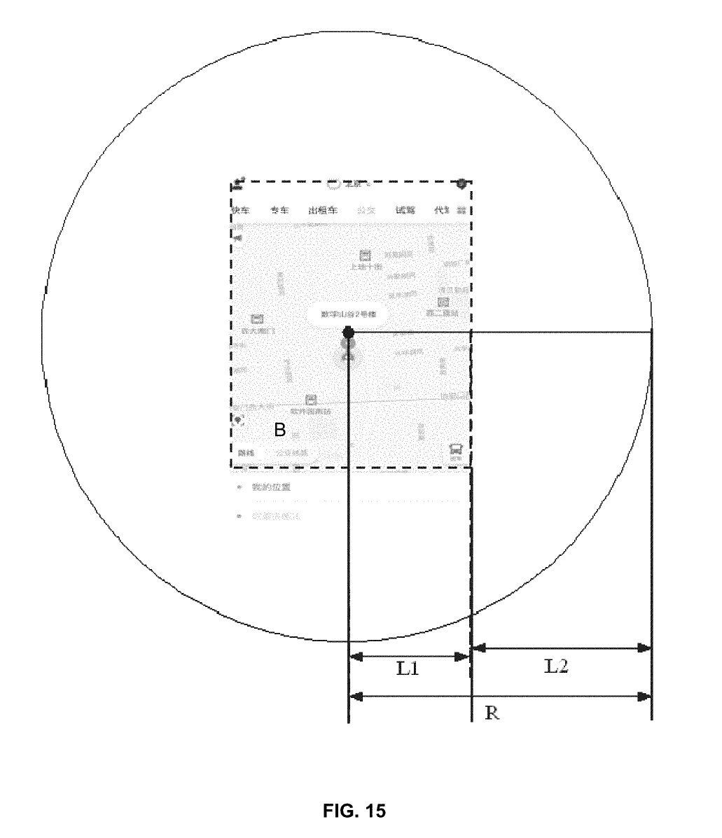

In some embodiments, the first predetermined distance may be a sum of the second predetermined distance and a distance between the first center position or the second center position to a boundary of the display area of the map. More descriptions for the first predetermined distance, the second predetermined distance, and the boundary of the display area of the map may be found in FIG. 15.

FIG. 9B is a flowchart illustrating another exemplary process for loading a station according to some embodiments of the present disclosure. In some embodiments, process 950 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 950. The operations of the illustrated process present below are intended to be illustrative. In some embodiments, process 950 may be accomplished with one or more additional operations not described and/or without one or more of the operations herein discussed. Additionally, the order in which the operations of the process as illustrated in FIG. 9B and described below is not intended to be limiting.

In 901, the processing engine 112 may position a current city where a user locates. The processing engine 112 may obtain position information of the current city where the user locates. The position information of the current city where the user locates may be obtained from a client terminal carried by the user. For example, the position information of the current city where the user locates may be determined by a positioning chipset of the client terminal carried by the user. As another example, the position information of the current city where the user locates may be input by the user via the user interface of the client terminal (e.g., a map application).

In 902, the processing engine 112 may obtain a current position of the user according to the position information of the current city where the user locates. The processing engine 112 may designate the current position of the user as a first center position of a map. As used herein, the current position of the user may be a geographic location of the user. The geographic location of the user may be obtained from a client terminal carried by the user according to the position information of the current city. For example, the client terminal may position and/or determine the geographic location of the user from the current city via a positioning chipset of the client terminal.

In 903, the processing engine 112 may load a plurality of first stations within a first predetermined distance from the first center position. In some embodiments, the processing engine 112 may display at least one portion of the plurality of first stations which are within the display area on the map.

In 905, the processing engine 112 may receive a signal including an operation instruction for changing the display area of the map from a client terminal.

In 907, the processing engine 112 may determine a distance between the first center position and a second center position associated with the changed display area of the map.

In 909, the processing engine 112 may determine whether the distance between the first center position and the second center position exceeds a second predetermined distance.

In 911, the processing engine 112 may load a plurality of second stations within the first predetermined distance from the second center position in response to a determination that the distance between the first center position and the second center position exceeds the second predetermined distance.

In 913, the processing engine 112 may display at least one portion of the plurality of second stations and/or at least one portion of the plurality of first stations which are within the changed display area on the map.

In 915, the processing engine 112 may display at least one portion of the plurality of first stations which are within the changed display area on the map in response to a determination that the distance between the first center position and the second center position is less than or equal to the second predetermined distance. More descriptions of operations 903-915 may be described in connection with operation 904 and 916 in FIG. 9A.

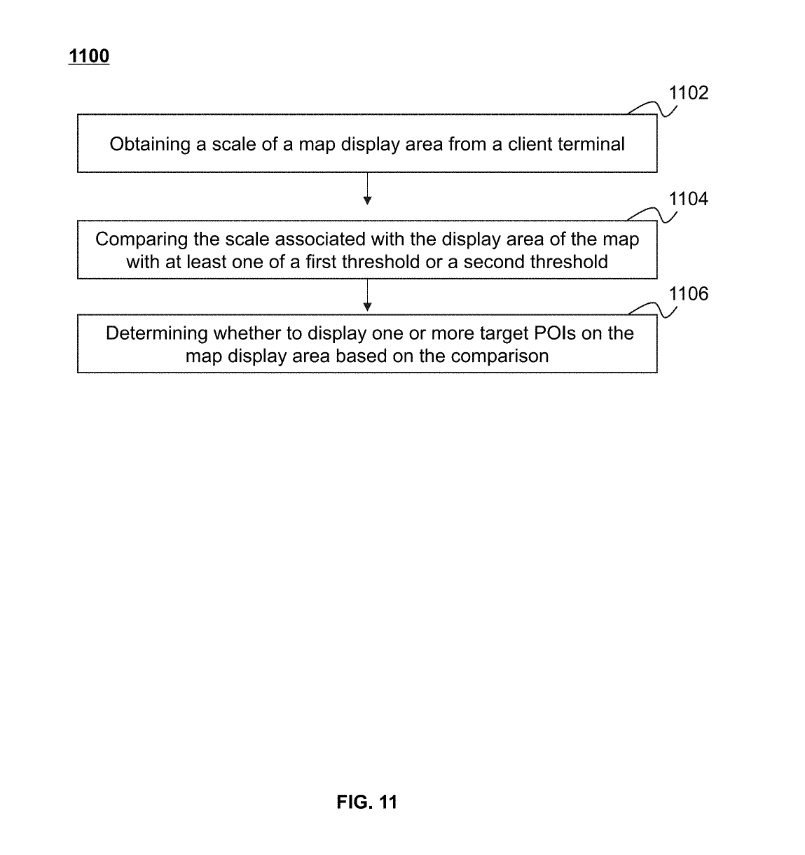

FIG. 10 is a block diagram illustrating another exemplary processing engine according to some embodiments of the present disclosure. The processing engine 112 may include an acquisition module 1002, a POI determination module 1004, a receiving module 1006, a display module 1008, a judging module 1010, and a storing module 1012. Each of the modules described above may be a hardware circuit that is designed to perform certain actions, e.g., according to a set of instructions stored in one or more storage media, and/or any combination of the hardware circuit and the one or more storage media.

The acquisition module 1002 may be configured to obtain a scale of a display area of a map from a client terminal. As used herein, the scale associated with the display area of a map may denote a relationship between a distance at ground (also referred to as actual distance) and a corresponding distance on the map (also referred to as map distance). In some embodiments, the scale associated with the display area of the map may be defined by a ratio of the actual distance to the map distance. The scale associated with the display area of the map defined by the ratio of the actual distance to the map distance may be greater than constant 1. For example, if the scale associated with the display area of the map is equal to 10, a map distance of 1 centimeter is equal to an actual distance of 10 meters. In some embodiments, the scale associated with the display area of the map may be defined by a ratio of the map distance to the actual distance. The scale associated with the display area of the map defined by the ratio of the map distance to the actual distance may be less than constant 1. For example, if the scale associated with the display area of the map is equal to 0.01, a map distance of 1 centimeter is equal to an actual distance of 10 meters.

In some embodiments, the acquisition module 1002 may obtain the scale associated with the display area of the map from a client terminal (e.g., the service requester terminal 130, the service provider terminal 140) via the network 120. For example, a user associated with the client terminal may input the scale associated with the display area of the map via a user interface implemented on the client terminal. As another example, the user may zoom in or out the display area via the interface area, and the acquisition module 1002 may determine the scale associated with the display area of the map based on the operation of the user.

The acquisition module 1002 may also be configured to obtain a current position of a user. As used herein, the current position of the user may be a geographic location of the user. The geographic location of the user may be associated with and obtained from a client terminal carried by the user. For example, the acquisition module 1002 may obtain the geographic location of the user based on the position information of the client terminal that is determined by a positioning chipset of the client terminal. As another example, the geographic location of the user may be inputted by the user via the user interface of the client terminal (e.g., a map application). In some embodiments, the acquisition module 1002 may obtain position information of the city where the user locates. The position information of the city where the user locates may be associated with and obtained from a client terminal carried by the user. For example, the position information of the city where the user locates may be determined by a positioning chipset of the client terminal carried by the user. Further, the acquisition module 1002 may, according to the position information of the city where the user currently locates, obtain the current position of the user.

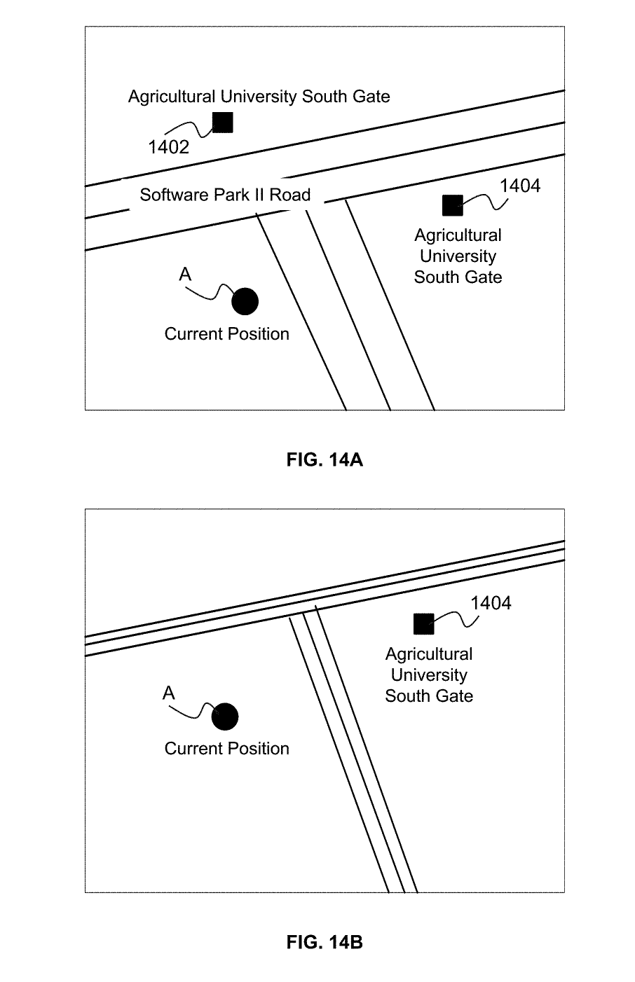

The POI determination module 1004 may be configured to determine one or more target POIs (POIs). A POI may include a station (e.g., a bus stop, a subway station, etc.), a parking lot, a supermarket, a shopping mall, a restaurant, etc. In some embodiments, the station may be an upstream station or a downstream station. As used herein, an upstream station may refer to a station associated with a travel route from a start point to a destination. A downstream station may refer to a station associated with another travel route from the destination to the start point. For example, if a travel route starts from Agricultural University South Gate 1302 to destination Software Park South Station 1308 as shown in FIG. 13, stations along the travel route from Agricultural University South Gate 1302 to destination Software Park South Station 1308 may be upstream stations. Stations along another travel route from destination Software Park South Station 1308 to Agricultural University South Gate 1302 may be downstream stations.

In some embodiments, the one or more target POIs may be determined by the POI determination module 1004 based on a query about a POI inputted by a user via a user interface of the client terminal (e.g., a map application). For example, the user interface of the client terminal (e.g., a map application) may receive a signal including a query about a POI and transmit the signal to the POI determination module 1004. The POI determination module 1004 may retrieve and/or determine one or more candidate POIs matching with the query about a POI from a predetermined POIs database based on the query about POI. In some embodiments, the POI determination module 1004 may determine and load the one or more target POIs within a predetermined distance from the current position of the user based on the one or more candidate POIs.

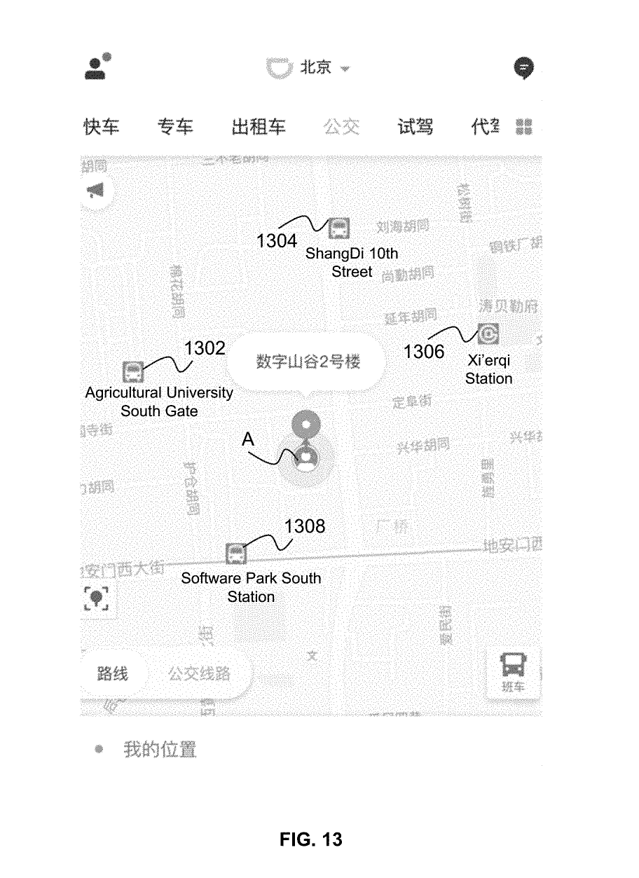

In some embodiments, the one or more target POIs may be determined based on a changed display area of the map or a changed current position. For example, the POI determination module 1004 may designate the current position of the user as a first center position of the display area of the map and load a plurality of first POIs within a first predetermined distance from the first center position of the display area of the map. The POI determination module 1004 may determine a second center of the changed display area of the map and load a plurality of second POIs within the first predetermined distance from the second center position of the changed display area of the map. The POI determination module 1004 may determine a distance between the first center position and the second center position and compare the distance with a second predetermined threshold. The POI determination module 1004 may determine the one or more targets POIs displayed on the map based on the comparison. For example, if the distance exceeds the second predetermined distance, the POI determination module 1004 may determine the one or more targets POIs from the plurality of the second stations and/or the plurality of the first stations. If the distance is less than the second predetermined distance, the POI determination module 1004 may determine the one or more targets POIs from the plurality of the first stations. Detailed descriptions about the determination of the one or more target POIs may be found in FIG. 12.

The receiving module 1006 may be configured to receive a signal from a client terminal. In some embodiments, the signal may indicate an operation instruction for changing the display area of the map. The receiving module 1006 may cause the client terminal (e.g., the map application) to change the display area of the map according to the operation instruction. In some embodiments, the operation instruction for changing the display area of the map may be generated by the user dragging the map via the user interface (e.g., a map application) of the client terminal. In some embodiments, the signal may indicate an operation instruction for zooming the map. The receiving module 1006 may cause the client terminal (e.g., the map application) to zoom in or out the map according to the operation instruction.

The display module 1008 may be configured to display at least one portion of the one or more target POIs on the changed display area of the map. In some embodiments, the one or more target POIs may include one or more upstream stations and one or more downstream stations. The display module 1008 may determine whether to display the one or more upstream stations and one or more downstream stations based on the comparison. For example, the display module 1008 may display the one or more upstream stations and one or more downstream stations of the one or more target POIs on the display area of the map in response to a determination that the scale associated with the display area of the map is less than or equal to a first threshold. The display module 1008 may display the one or more upstream stations or one or more downstream stations of the one or more target POIs on the display area of the map in response to a determination that the scale associated with the display area of the map is greater than the first threshold and is less than or equal to a second threshold. The display module 1008 may display neither the one or more upstream stations nor one or more downstream stations of the one or more target POIs on the display area of the map in response to a determination that the scale associated with the display area of the map is greater than the second threshold.

As another example, the display module 1008 may display the one or more upstream stations and one or more downstream stations of the one or more target POIs on the display area of the map in response to a determination that the scale associated with the display area of the map is less than the first threshold. The display module 1008 may display the one or more upstream stations or one or more downstream stations of the one or more target POIs on the display area of the map in response to a determination that the scale associated with the display area of the map is greater than or equal to the first threshold and is less than the second threshold. The display module 1008 may display neither the one or more upstream stations nor one or more downstream stations of the one or more target POIs on the display area of the map in response to a determination that the scale associated with the display area of the map is greater than or equal to the second threshold.

In some embodiments, the display module 1008 may further determine the number of the target POIs displayed on the display area of the map based on the comparison. For example, if the scale associated with the display area of the map is less than or equal to the first threshold, the display module 1008 may determine a first number of the target POIs on the map and display the first number of the target POIs on the map. If the scale associated with the display area of the map is greater than the first threshold and is less than the second threshold, the display module 1008 may determine a second number of the target POIs displayed on the map and display the second number of the target POIs on the map. If the scale associated with the display area of the map is greater than or equal to the second threshold, the display module 1008 may determine a third number of the target POIs displayed on the map and display the third number of the target POIs on the map. The first number may be greater than the second number, and the second number may be greater than the third number. In some embodiments, the third number may be equal to 0.

The judging module 1010 may be configured to determine a distance between the first center position and the second center position. The judging module 1010 may compare the distance between the first center position and the second center position with a second predetermined distance. If the distance between the first center position and the second center position is determined to be greater than a second predetermined distance, the judging module 1010 may cause the POI determination module 1004 to load a plurality of second POIs within the first predetermined distance from the second center position of the changed display area of the map. Each of the plurality of second stations may be different from one of the plurality of first stations. In other words, one or more stations of the plurality of first stations loaded within the first predetermined distance from the second center position may be not loaded once again.

The judging module 1010 may also be configured to compare the scale associated with the display area of the map with the first threshold and/or the second threshold. In some embodiments, the first threshold may be 10, and the second threshold may be 100. For example, if the judging module 1010 determines the scale associated with the display area of the map less than or equal to the first threshold, the display module 1008 may display the one or more upstream stations and one or more downstream stations on the display area of the map. If the judging module 1010 determines the scale associated with the display area of the map greater than or equal to the first threshold and less than or equal to the second threshold, the display module 1008 may display the one or more upstream stations or one or more downstream stations on the display area of the map. If the judging module 1010 determines the scale associated with the display area of the map greater than or equal to the second threshold, the display module 1008 to display neither the one or more upstream stations nor one or more downstream stations on the display area of the map.

The storing module 1012 may be configured to store data and/or instructions. In some embodiments, the storage 150 may store data and/or instructions that the processing engine 112 may execute or use to perform exemplary methods described in the present disclosure. For example, the current position of the user, the first center position of the map, the second center position of the map, the signal indicating changing the display area of the map, etc. may be stored in the storing module 1012. In some embodiments, storage 150 may include a mass storage, removable storage, a volatile read-and-write memory, a read-only memory (ROM), or the like, or any combination thereof. In some embodiments, the display module 1008 may be integrated into a client terminal (e.g., the service requester terminal 130, the service provider terminal 140, etc.).

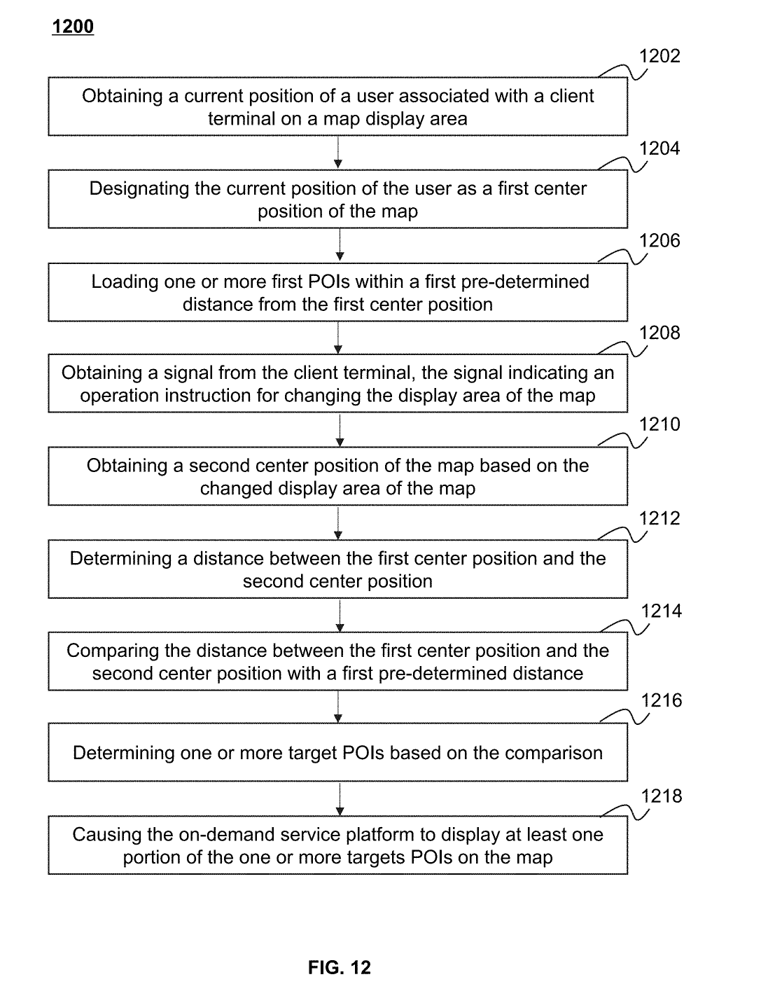

FIG. 11 is a flowchart illustrating an exemplary process for displaying one or more target POIs according to some embodiments of the present disclosure. In some embodiments, process 1100 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 1100. The operations of the illustrated process present below are intended to be illustrative. In some embodiments, process 500 may be accomplished with one or more additional operations not described and/or without one or more of the operations herein discussed. Additionally, the order in which the operations of the process as illustrated in FIG. 11 and described below is not intended to be limiting.

In 1102, the processing engine 112 may obtain a scale of a display area of a map from a client terminal. As used herein, the scale associated with the display area of a map may denote a relationship between a distance at ground (also referred to as actual distance) and a corresponding distance on the map (also referred to as map distance). In some embodiments, the scale associated with the display area of the map may be defined by a ratio of the actual distance to the map distance. The scale associated with the display area of the map defined by the ratio of the actual distance to the map distance may be greater than constant 1. For example, if the scale associated with the display area of the map is equal to 10, a map distance of 1 centimeter is equal to an actual distance of 10 meters. In some embodiments, the scale associated with the display area of the map may be defined by a ratio of the map distance to the actual distance. The scale associated with the display area of the map defined by the ratio of the map distance to the actual distance may be less than constant 1. For example, if the scale associated with the display area of the map is equal to 0.01, a map distance of 1 centimeter is equal to an actual distance of 10 meters.

In some embodiments, the scale associated with the display area of the map may vary with the units of the actual distance and the map distance. For example, if a map distance is 1 centimeter, and an actual distance is 1000 centimeters, the scale associated with the display area of the map defined by the ratio of the actual distance to the map distance may be 1000. If a map distance is 1 centimeter, and an actual distance is 10 meters (i.e., 1000 centimeters), the scale associated with the display area of the map defined by the ratio of the actual distance to the map distance may be 10. In some embodiments, the processing engine 112 may obtain the scale associated with the display area of the map from a client terminal (e.g., the service requester terminal 130, the service provider terminal 140) via the network 120. For example, a user may input the scale associated with the display area of the map via a user interface (e.g., a map application) implemented on the client terminal. As another example, the user may zoom in or out the display area via the interface area, and the processing engine 112 may determine the scale associated with the display area of the map based on the operation of the user.

In 1104, the processing engine 112 may compare the scale associated with the display area of the map with at least one of a first threshold or a second threshold. The first threshold and/or the second threshold may be a constant. In some embodiments, the second threshold may be greater than the first threshold. For example, the first threshold may be 10, and the second threshold may be 100. In some embodiments, the first threshold and/or the second threshold may be set by a user via a user interface implemented on a client terminal. In some embodiments, the first threshold and/or the second threshold may be set according to a default setting of the online to offline service system 100. For example, the processing engine 112 may set the first threshold and/or the second threshold according to the scale associated with the display area of the map. If the scale associated with the display area of the map is defined by a ratio of the map distance to the actual distance (i.e., smaller than 1), the processing engine 112 may set the first threshold and/or the second threshold smaller than 1. If the scale associated with the display area of the map is defined by a ratio of the map distance to the actual distance (i.e., greater than 1), the processing engine 112 may set the first threshold and/or the second threshold greater than 1. As another example, the processing engine 112 may set the first threshold and/or the second threshold based on the total number of candidate POIs within a predetermined distance from a current position of the user. The greater the total number of candidate POIs is, the smaller the first threshold and/or the second threshold may be.

In 1106, the processing engine 112 may determine whether to display one or more target points of interest (POIs) on the display area of the map based on the comparison. A POI may include a station (e.g., a bus stop, a subway station, etc.), a parking lot, a supermarket, a shopping mall, a restaurant, etc. In some embodiments, the station may be an upstream station or a downstream station. As used herein, an upstream station may refer to a station associated with a travel route from a start point to a destination. A downstream station may refer to a station associated with another travel route from the destination to the start point. For example, if a travel route starts from Agricultural University South Gate 1302 to destination Software Park South Station 1308 as shown in FIG. 13, stations along the travel route from Agricultural University South Gate 1302 to destination Software Park South Station 1308 may be upstream stations. Stations along another travel route from destination Software Park South Station 1308 to Agricultural University South Gate 1302 may be downstream stations.

In some embodiments, the one or more target POIs may be determined by the processing engine 112 based on a query about a POI. The query about a POI may be inputted by a user via a user interface of the client terminal (e.g., a map application). The processing engine 112 may retrieve and/or determine one or more candidate POIs matching with the query about a POI from a predetermined POI database based on the query about a POI. In some embodiments, the processing engine 112 may determine and load the one or more target POIs within a predetermined distance from the current position of the user based on the one or more candidate POIs. In some embodiments, the processing engine 112 may receive a signal including an operation instruction for changing a display area of a map or the current position of the user, such as dragging the display area of the map. The one or more target POIs may be determined based on the changed display area of the map or the changed current position. For example, the processing engine 112 may designate the current position of the user as a first center position of the display area of the map and load a plurality of first POIs within a first predetermined distance from the first center position of the display area of the map. The processing engine 112 may determine a second center of the changed display area of the map and load a plurality of second POIs within the first predetermined distance from the second center position of the changed display area of the map. The processing engine 112 may determine a distance between the first center position and the second center position and compare the distance with a second predetermined threshold. The processing engine 112 may determine the one or more targets POIs displayed on the map based on the comparison. For example, if the distance exceeds the second predetermined distance, the processing engine 112 may determine the one or more targets POIs from the plurality of the second POIs and/or the plurality of the first POIs. If the distance is less than the second predetermined distance, the processing engine 112 may determine the one or more targets POIs from the plurality of the first POIs. Detailed descriptions about the determination of the one or more target POIs may be found in FIG. 12.

In some embodiments, the one or more target POIs may include one or more upstream stations and one or more downstream stations. The processing engine 112 may determine whether to display the one or more upstream stations and one or more downstream stations based on the comparison. For example, the processing engine 112 may cause a client terminal to display the one or more upstream stations and one or more downstream stations on the display area of the map in response to a determination that the scale associated with the display area of the map is less than or equal to the first threshold. The processing engine 112 may cause the client terminal to display the one or more upstream stations or one or more downstream stations on the display area of the map in response to a determination that the scale associated with the display area of the map is greater than the first threshold and is less than or equal to the second threshold. The processing engine 112 may cause the client terminal to display neither the one or more upstream stations nor one or more downstream stations on the display area of the map in response to a determination that the scale associated with the display area of the map is greater than the second threshold.

As another example, the processing engine 112 may cause a client terminal to display the one or more upstream stations and one or more downstream stations on the display area of the map in response to a determination that the scale associated with the display area of the map is less than the first threshold. The processing engine 112 may cause the client terminal to display the one or more upstream stations or one or more downstream stations on the display area of the map in response to a determination that the scale associated with the display area of the map is greater than or equal to the first threshold and is less than the second threshold. The processing engine 112 may cause the client terminal to display neither the one or more upstream stations nor one or more downstream stations on the display area of the map in response to a determination that the scale associated with the display area of the map is greater than or equal to the second threshold.

In some embodiments, the processing engine 112 may further determine the quantity of target POIs displayed on the display area of the map based on the comparison. For example, if the scale associated with the display area of the map is less than or equal to the first threshold, the processing engine 112 may determine a first quantity of target POIs on the map and cause the client terminal to display the first quantity of target POIs on the map. If the scale associated with the display area of the map is greater than the first threshold and less than the second threshold, the processing engine 112 may determine a second quantity of target POIs displayed on the map and cause the client terminal to display the second quantity of target POIs on the map. If the scale associated with the display area of the map is greater than or equal to the second threshold, the processing engine 112 may determine a third quantity of target POIs displayed on the map and cause the client terminal to display the third quantity of target POIs on the map. The first quantity may be greater than the second quantity, and the second quantity may be greater than the third quantity. In some embodiments, the third quantity may be equal to 0. In some embodiments, the first quantity, the second quantity, and/or the third quantity may be determined by the user via the user interface of the client terminal or according to a default setting of the system 100.

In some embodiments, the processing engine 112 may cause the client terminal to display information or data associated with the one or more target POIs on the map. Exemplary information or data associated with a target POI may include the name of the target POI, an icon representing the target POI, or any other identifier for distinguishing the target POI from other POIs.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, process 1100 may further include determining a current position of the user and determine one or more target POIs based on the current position of the user.

FIG. 12 is a flowchart illustrating an exemplary process for loading and displaying one or more target POIs according to some embodiments of the present disclosure. In some embodiments, process 1200 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 1200. The operations of the illustrated process present below are intended to be illustrative. In some embodiments, process 500 may be accomplished with one or more additional operations not described and/or without one or more of the operations herein discussed. Additionally, the order in which the operations of the process as illustrated in FIG. 12 and described below is not intended to be limiting.

In 1202, the processing engine 112 may obtain a current position of a user associated with a client terminal on a display area of a map. As used herein, the current position of the user may be a geographic location of the user. The geographic location of the user may be associated with and obtained from a client terminal carried by the user. For example, the processing engine 112 may obtain the geographic location of the user based on the position information of the client terminal that is determined by a positioning chipset of the client terminal. As another example, the geographic location of the user may be inputted by the user via the user interface of the client terminal (e.g., a map application).

In 1204, the processing engine 112 may designate the current position of the user as a first center position of the map. In some embodiments, a center position of a map may refer to a location on the map corresponding to a geometric center of the display area of the map. If the display area of the map changes, the geometric center of the display area of the map may not change, but the location on the map corresponding to the geometric center of the display area of the map may change.

In 1206, the processing engine 112 may load one or more first POIs within a first predetermined distance from the first center position. A POI may include a station (e.g., a bus stop, a subway station, etc.), a parking lot, a supermarket, a shopping mall, a restaurant, etc. In some embodiments, the processing engine 112 may retrieve and/or determine the one or more first POIs from a POI database. The processing engine 112 may further obtain information and/or data associated with each of the one or more first POIs. The information and/or data associated with a first POI may include the name of the first POI, the address of the first POI, an identifier associated with the first POI (e.g., an icon), etc.

In 1208, the processing engine 112 may obtain a signal from the client terminal. The signal may indicate an operation instruction for changing the display area of the map. The processing engine 112 may cause the client terminal (e.g., the map application) to change the display area of the map according to the operation instruction. In some embodiments, the operation instruction for changing the display area of the map may be generated by the user via dragging the map via the user interface (e.g., a map application) of the client terminal. In some embodiments, the operation instruction for changing the display area of the map may be generated by the user moving the current position (e.g., point A as shown in FIG. 13) of the user via the user interface (e.g., a map application) of the client terminal.

In 1210, the processing engine 112 may obtain a second center position of the map based on the changed display area of the map. In some embodiments, in response to the user dragging the map or moving the current position, the processing engine 112 may determine the changed display area of the map. The processing engine 112 may then designate a location corresponding to the geometric center of the changed display area of the map as the second center position. In some embodiments, the processing engine 112 may designate the moved current position as the second center position of the changed display area of the map.

In 1212, the processing engine 112 may determine a distance between the first center position and the second center position. In some embodiments, the distance between the first center position and the second center position may be a map distance between the first center position and the second center position on the map. The processing engine 112 may determine the map distance between the first center position and the second center position based on pixel coordinates (e.g., CSS pixel coordinates) of the display of the client terminal. In some embodiments, the distance between the first center position and the second center position may be an actual distance corresponding to the map distance between the first center position and the second center position. Merely by way of example, the processing engine 112 may determine the actual distance between the first center position and the second center position by multiplying the corresponding map distance with the scale associated with the display area of the map.

In 1214, the processing engine 112 may compare the distance between the first center position and the second center position with a second predetermined distance. The second predetermined distance may be determined based on the first predetermined distance. In some embodiments, the first predetermined distance may be a sum of the second predetermined distance and a distance between the first center position or the second center position to the boundary of the display area of the map (e.g., the boundary of the display area denoted by dotted lines as shown in FIG. 15). The distance between the first center position or the second center position and the boundary of the display area of the map may be a minimum distance from the first center position or the second center position to the boundary of the display area of the map in a horizontal direction or vertical direction. More descriptions of the first predetermined distance and the second predetermined distance may be found in FIG. 15.

In 1216, the processing engine 112 may determine one or more target POIs based on the comparison. The processing engine 112 may load one or more second POIs within the first predetermined distance from the second center position in response to a determination that the distance between the first center position and the second center position exceeds the second predetermined distance. Each of the one or more second POIs may be different from one of the one or more first POIs, that means if a first POI loaded in operation 1206 is within the first predetermined distance from the second center position, the first POI may be not loaded in operation 1216.

In some embodiments, the processing engine 112 may determine the one or more target POIs by determining whether the distance between the first center position and the second center position exceeds the second predetermined distance. If the distance between the first center position and the second center position exceeds the second predetermined distance, the processing engine 112 may determine at least one portion of the one or more second POIs and at least one portion of the one or more first POIs within the changed display area of the map as the one or more target POIs. If the distance between the first center position and the second center position is less than the second predetermined distance, the processing engine 112 may determine at least one portion of the one or more first POIs within the changed display area of the map as the one or more target POIs.

In 1218, the processing engine 112 may cause the on-demand service platform to display at least one portion of the one or more target POIs on the changed display area of the map. In some embodiments, the processing engine 112 may cause the on-demand service platform to display information and/or data associated with each of the at least one portion of the one or more target POIs on the changed displayed area of the map. Exemplary information and/or data associated with a target POI may include the name of the target POI, an identifier of the target POI, etc.

In some embodiments, the processing engine 112 may cause the on-demand service platform to display at least one portion of the one or more targets POIs on the changed display area of the map according to a scale associated with the changed display area of the map. For example, the one or more target POIs may include one or more upstream stations and one or more downstream stations. The processing engine 112 may cause the on-demand service platform to display the one or more upstream stations and one or more downstream stations on the changed display area of the map in response to a determination that the scale associated with the changed display area of the map is less than or equal to a first threshold. The processing engine 112 may cause the on-demand service platform to display the one or more upstream stations or one or more downstream stations on the changed display area of the map in response to a determination that the scale associated with the changed display area of the map is greater than the first threshold and less than or equal to the second threshold. The processing engine 112 may cause the on-demand service platform to display neither the one or more upstream stations nor one or more downstream stations on the changed display area of the map in response to a determination that the scale associated with the changed display area of the map is greater than the second threshold.

As another example, the processing engine 112 may cause the on-demand service platform to display the one or more upstream stations and one or more downstream stations of the one or more target POIs on the changed display area of the map in response to a determination that the scale associated with the changed display area of the map is less than the first threshold. The processing engine 112 may cause the on-demand service platform to display the one or more upstream stations or one or more downstream stations of the one or more target POIs on the changed display area of the map in response to a determination that the scale associated with the changed display area of the map is greater than or equal to the first threshold and is less than the second threshold. The processing engine 112 may cause the on-demand service platform to display neither the one or more upstream stations nor one or more downstream stations of the one or more target POIs on the changed display area of the map in response to a determination that the scale associated with the changed display area of the map is greater than or equal to the second threshold.

In some embodiments, the first threshold may be 10, and the second threshold may be 100. In some embodiments, if the scale associated with the changed display area of the map is equal to 10, a map distance of 1 centimeter is equal to an actual distance of 10 meters. If the scale associated with the changed display area of the map is equal to 100, a map distance of 1 centimeter is equals to an actual distance of 100 meters. It should be noted that the unit of the actual distance is meters, and the unit of the map distance is centimeters. In some embodiments, the unit of the actual distance and the unit of the map distance may be unified, and the value of the first threshold and the second threshold may be changed accordingly.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, process 1200 may further include causing the client terminal to display at least one portion of the one or more POIs within the display area of the map on the map.

FIG. 13 is a schematic diagram illustrating an exemplary display interface of a map application according to some embodiments of the present disclosure. As shown in FIG. 13, a plurality of stations (e.g., Agricultural University South Gate 1302, ShangDi 10th Street 1304, Xi'erqi Station 1306, Software Park South Station 1308, etc.) and the current position of the user (denoted by point A) are displayed on the display area of the map. The scale associated with the display area of a map may denote a relationship between a distance at ground (also referred to as actual distance) and a corresponding distance on the map (also referred to as map distance). For example, the map distance may be 1 centimeter and the actual distance may be 100 meters, the scale associated with the display area of the map may be a ratio of the map distance 1 centimeter to the actual distance 100 meters, i.e., 0.01. As another example, the scale associated with the display area of the map may be a ratio of the actual distance 100 meters centimeters to the map distance 1, i.e., 100.

In some embodiments, the plurality of stations displayed on the map as shown in FIG. 13 may be at least one portion of a plurality of first stations as described in FIG. 9A and FIG. 9B. The plurality of stations may be within a first predetermined distance from the current position of the user (i.e., the first center position of the display area of the map). In some embodiments, the plurality of stations displayed on the map as shown in FIG. 13 may be at least one portion of the plurality of second stations and/or the plurality of first stations as descried in FIG. 9A and FIG. 9B. After the user moves the display area of the map, the display area of the map may change, and the center position of the changed display area of the map (i.e., the second center position) may be different from the first center position. If the distance between the first center position and the second center position exceeds a second predetermined distance, a plurality of second stations may be loaded. At least one portion of the plurality of second stations and at least one portion of the plurality of first stations within the changed displayed area may be displayed on the map. If the distance between the first center position and the second center position is less than or equal to the second predetermined distance, at least one portion of the plurality of first stations within the changed displayed area may be displayed on the map. The first predetermined distance may be a sum of the second predetermined distance and a distance between the first center position or the second center position to the boundary of the display area of the map. More descriptions for the first predetermined distance, the second predetermined distance, and the boundary of the display area of the map may be found in FIG. 15.

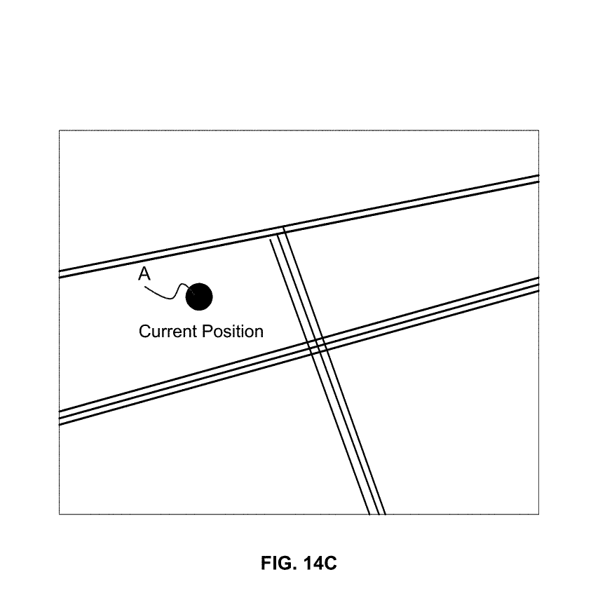

FIGS. 14A-14C are schematic diagrams illustrating displaying one or more stations on the map as shown in FIG. 13 according to some embodiments of the present disclosure. After the user zooms the map as shown in FIG. 13, the processing engine 112 may perform different display modes for one or more stations based on the range that the changed scale associated with the display area of the map belongs. The range that the changed scale associated with the display area of the map belongs may be defined by a first threshold and a second threshold as described in connection with FIGS. 6 and 7. For example, if the first threshold is equal to 10, a first range may be from 0 to 10. If the second threshold is equal to 100, a second range may be from 10 to 100, and a third range may be from 100 to other constant values greater than 100. If the changed scale associated with the display area of the map is less than or equal to 10 (i.e., the changed scale associated with the display area of the map is in the first range), the processing engine 112 may display one or more upstream stations and one or more downstream stations on the display area of the map. As shown in FIG. 14A, and an upstream station Agricultural University South Gate 1404 and a downstream station Agricultural University South Gate 1402 are both displayed on the display area of the enlarged map. If the changed scale associated with the display area of the map is greater than 10 and is less than or equal to 100 (i.e., the changed scale associated with the display area of the map is in the second range), the processing engine 112 may display an upstream station or a downstream station on the display area of the map. As shown in FIG. 14B, the processing engine 112 only displays an upstream station (e.g., Agricultural University South Gate 1404) on the display area of the zoomed map instead of displaying all of the upstream stations and downstream stations, which may avoid stations overlapping caused by displaying both the upstream station and the downstream station on the map. If the changed scale associated with the display area of the map is greater than 100 (i.e., the changed scale associated with the display area of the map is in the third range), the processing engine 112 hides the upstream station and the downstream station. As shown in FIG. 14C, there is no station around the current position of the user is displayed on the display area of the zoomed map.

FIG. 15 is a schematic diagram illustrating an exemplary display interface of a map application according to some embodiments of the present disclosure. As shown in FIG. 15, the first predetermined distance as described in FIG. 13 is denoted by R, the second predetermined distance is denoted by L2, and the distance between the first center position or the second center position (denoted by point B) to the boundary of the display area of the map (denoted by dotted lines) is denoted by L1. The first predetermined distance may be a sum of the second predetermined distance and a distance between the first center position or the second center position to the boundary of the display area of the map. For example, the first predetermined distance R may be equal to 10 centimeters indicating an actual distance of 1000 meters. The second predetermined distance L2 may be equal to 7 centimeters indicating an actual distance of 700 meters. The distance L1 between the first center position or the second center position to the boundary of the display area of the map equal to 3 centimeters indicating an actual distance of 300 meters.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for stations display, comprising:
a storage device storing a set of instructions; and
one or more processors in communication with the storage device, wherein when executing the set of instructions, the one or more processors are configured to cause the system to:
obtain a scale associated with a display area of a map; and
determine whether to display one or more stations on the display area of the map based on the scale associated with the display area of the map.

2. The system of claim 1, wherein the one or more stations include at least one of an upstream station or a downstream station, and to determine whether to display one or more stations on the display area of the map, the one or more processors are configured to cause the system to:
display at least one of the upstream station or the downstream station on the display area of the map; or
display neither the upstream station nor the downstream station on the display area of the map.

3. The system of claim 2, wherein the one or more processors are configured to cause the system to:
display the upstream station and the downstream station on the display area of the map in response to a determination that the scale associated with the display area of the map is less than or equal to a first threshold;
display the upstream station or the downstream station on the display area of the map in response to a determination that the scale associated with the display area of the map exceeds the first threshold and is less than or equal to a second threshold; or
display neither the upstream station nor the downstream station on the display area of the map in response to a determination that the scale associated with the display area of the map exceeds the second threshold.

4. The system of claim 2, wherein the one or more processors are configured to cause the system to:
display the upstream station and the downstream station on the display area of the map in response to a determination that the scale associated with the display area of the map is less than a first threshold;
display the upstream station or the downstream station on the display area of the map in response to a determination that the scale associated with the display area of the map exceeds or equals the first threshold and is less than a second threshold; and
display neither the upstream station nor the downstream station on the display area of the map in response to a determination that the scale associated with the display area of the map exceeds or equals the second threshold.

5. (canceled)

6. The system of claim 1, wherein to obtain a scale associated with a display area of a map from a client terminal, the one or more processors are configured to cause the system to:
receive a signal from a client terminal, the signal indicating an operation instruction for zooming the display area of the map; and
determine the scale associated with the display area of the map based on the signal.

7. A system for stations display, comprising:
a storage device storing a set of instructions; and
one or more processors in communication with the storage device, wherein when executing the set of instructions, the one or more processors are configured to cause the system to:
obtain a current position of a user, the current position being a first center position of a map;
load a plurality of first stations within a first pre-determined distance from the first center position;
display a first sets of stations including at least one portion of the plurality of first stations within a display area of the map on the map;
receive a signal from a client terminal, the signal including an operation instruction for changing the display area of the map;
obtain a second center position of the map based on the changed display area of the map;
determine a distance between the first center position and the second center position;
determine whether the distance between the first center position and the second center position exceeds a second pre-determined distance;
load a plurality of second stations within the first pre-determined distance from the second center position in response to a determination that the distance between the first center position and the second center position exceeds the second pre-determined distance, each of the plurality of second stations being different from one of the plurality of first stations; and
display a second set of stations including at least one portion of the plurality of second stations within the changed display area of the map on the map.

8. The system of claim 7, wherein the one or more processors are further configured to cause the system to:
display the first set of stations on the map in response to a determination that the distance is less than or equal to the second pre-determined distance.

9. The system of claim 7, wherein to obtain a current position of a user, the one or more processors are further configured to cause the system to:
determine a current city the user locates at; and
obtain the current location of the user based on the current city the user locates at.

10. The system of claim 7, wherein the first pre-determined distance equals to a sum of the second pre-determined distance and a distance between a boundary of the display area of the map and the first center position or the second center position.

11. A system for displaying points of interest (POIs) by interacting with an on-demand service platform associated with a client terminal, comprising:
a storage device storing a set of instructions; and
one or more processors in communication with the storage device, wherein when executing the set of instructions, the one or more processors are configured to cause the system to:
obtain a scale associated with a display area of a map from the client terminal, the scale associated with the display area of the map being a relationship between a distance at ground and a corresponding distance on the map;
compare the scale associated with the display area of the map with at least one of a first threshold or a second threshold; and
determine whether to cause the on-demand service platform to display one or more target POIs on the map display area based on the comparison.

12. The system of claim 11, wherein the one or more targets POIs include at least one of an upstream station or a downstream station.

13. The system of claim 12, wherein to determine whether to cause the on-demand service platform to display one or more target POIs on the map based on the comparison, the one or more processors are configured to cause the system to:
cause the on-demand service platform to display the upstream station and the downstream station on the map in response to a determination that the scale associated with the display area of the map is less than or equal to the first threshold.

14. The system of claim 12, wherein to determine whether to cause the on-demand service platform to display one or more target POIs on the map based on the comparison, the one or more processors are configured to cause the system to:
cause the on-demand service platform to display one of the upstream station and the downstream station on the map in response to a determination that the scale associated with the display area of the map is greater than or equal to the first threshold and is less than or equal to the second threshold.

15. The system of claim 12, wherein to determine whether to cause the on-demand service platform to display one or more target POIs on the map based on the comparison, the one or more processors are configured to cause the system to:
cause the on-demand service platform to display neither the upstream station nor the downstream station on the map in response to a determination that the scale associated with the display area of the map is greater than or equal to the second threshold.

16. The system of claim 11, wherein the first threshold is less than or equal to 10, and the second threshold is greater than or equal to 100.

17. The system of claim 11, wherein to obtain a display ratio of the map relating to the first region, the one or more processors are configured to cause the system to:
receive a signal from the client terminal provided by the on-demand service platform, the signal indicating an operation instruction for zooming the display area of the map; and
determine the scale associated with the display area of the map based on the signal.

18. The system of claim 11, wherein to determine the one or more target POIs, the one or more processors are further configured to cause the system to:
obtain a current position of a user associated with the client terminal on a display area of the map, the current position of the user being provided by the on-demand service platform;
designate the current position of the user as a first center position of the map;
load one or more first POIs within a first pre-determined distance from the first center position;
obtain a signal from the client terminal, the signal indicating an operation instruction for changing the display area of the map;
obtain a second center position of the map based on the changed display area of the map;
determine a distance between the first center position and the second center position;
compare the distance between the first center position and the second center position with a second pre-determined distance; and
determine one or more target POIs based on the comparison.

19. The system of claim 18, wherein to determine the one or more target POIs based on the comparison, the one or more processors are further configured to cause the system to:
in response to a determination that the distance between the first center position and the second center position is less than or equal to the second pre-determined distance; and
determine the one or more targets POIs based on the one or more first POIs.

20. The system of claim 18, wherein to determine the one or more target POIs based on the comparison, the one or more processors are further configured to cause the system to:
in response to a determination that the distance between the first position and the second position is greater than or equal to the second pre-determined distance, load one or more second POIs within the first pre-determined distance from the second center position; and
determine the one or more targets POIs based on the one or more second POIs and the one or more first POIs.

21. The system of claim 18, wherein the second pre-determined distance is associated with a distance between the first position or the second position and a boundary of the display area of the map.

22-42. (canceled)
